(19) United States
(12) Patent Application Publication
(10) Pub. No.: US 2017/0354887 A1
(43) Pub. Date: Dec. 14, 2017

(54) SYSTEMS & METHODS FOR PARACHUTE FLIGHT SIMULATION

(71) Applicants: BRUCE BOLLERMANN, SCOTTSDALE, AZ (US); LONNE OSBORN, APACHE JUNCTION, AZ (US); RONALD HUGHAN, NEW PALTZ, NY (US)

(72) Inventors: BRUCE BOLLERMANN, SCOTTSDALE, AZ (US); LONNE OSBORN, APACHE JUNCTION, AZ (US); RONALD HUGHAN, NEW PALTZ, NY (US)

(21) Appl. No.: 15/618,064

(22) Filed: Jun. 8, 2017

Related U.S. Application Data
(60) Provisional application No. 62/347,195, filed on Jun. 8, 2016.

(51) Int. Cl. A63F 13/57; A63F 13/35; A63F 13/25

(52) U.S. Cl. CPC A63F 13/57; A63F 13/25; A63F 13/35

(57) ABSTRACT

The present invention contemplates parachute flight simulation enabled by systems, computer-implemented methods and computer program product that accurately incorporates realistic and real data such as satellite imagery and ground level buildings, trees, terrain, elevation, and other topographic detail. Aspects of embodiments of the present invention also contemplate a scalable platform enabling multiple players to engage in the parachute flight simulation. Aspects of embodiments of the present invention also contemplate an aeromechanics program that is a six degrees-of-freedom parafoil trajectory simulation computer program designed to train skydivers to control and accurately navigate the parafoil from deployment to landing.

### CROSS-REFERENCE TO RELATED APPLICATIONS

This application claims the benefit of, and is related to, the following Applicant's provisional patent application: U.S. Provisional Patent Application No. 62/347,195 titled “SYSTEMS & METHODS FOR PARACHUTE FLIGHT SIMULATION” filed Jun. 8, 2017 which is incorporated herein in its entirety.

### FIELD OF THE INVENTION

The present invention pertains to parachute flight simulation, in particular parachute flight simulation enabled by systems, computer-implemented methods and computer program product that accurately incorporates realistic and real data such as satellite imagery and ground level buildings, trees, terrain, elevation, and other topographic detail.

### BACKGROUND OF THE INVENTION

Parachuting is performed throughout the world by militaries for supply and insertion, astronauts and pilots in emergency situations, forest firefighters, recreational and sport enthusiasts, and those seeking entertainment. Training is provided at all levels to establish and safeguard the lives and well-being of participants.

Learning to successfully jump from altitude and deploy, fly, and land a parachute, is unsafe without a high level of instruction. Current learning methods involve either high risk jumps, or ironically for convenience and low risk the skydiver must inconveniently travel to the location of unwieldy, exorbitant costing, and awkwardly dedicated equipment.

In 2014, eleven of the twenty-four skydive fatalities in the USA were caused by either the parachutist not surviving their landing under a fully-functional parachute (they did a low turn just before hitting the ground), or their collision with another parachutist resulted in one or both parachutes collapsing. Freefall collisions also occur. Extensive investigation conducted by the United States Parachute Association (USPA) determined that a common factor leading to such parachuting incidents is poor decision making by the deceased. As such, there exists a need for a virtual skydiving and parachute flight simulator which would allow skydiving and especially parachuting practice in making good decisions without the risk of death or injury attributed to actual accidents that may occur in real life parachute drops.

Initially, learning to jump and use a parachuting system was confined to daredevils taking high risk. The risk of learning how to parachute has been partially reduced by the introduction of the static line, tandem, and instructor aided freefall methods. Static line was created to allow a jumper's parachute to deploy automatically by attaching rigid cord line from the plane to the parachute rip cord. Tandem allows a harnessed passenger attached to a professional to experience the jump out of an airplane safely and receive modest schooling. Instructor aided freefalls provide hands-on guidance, and a last chance to amateur trained parachutists. These methods require necessary firsthand training but with a risk.

More recent modern methods have been developed but these all utilize quite bulky, expensive, old-fashioned, difficult to setup, and outdated equipment, with unrealistic drop zones or landing areas, and these methods require the skydiver to transport themselves to the site of said equipment. We discuss vertical wind tunnels, large sized simulators, entertaining video games, and patent prior art.

Vertical wind tunnels, such as those provided by Skyventure and iFly, are extremely expensive to build and maintain, costing around $7 million dollars in 2007. Wind tunnels lower risks in ways not requiring a person to jump from an airplane, but for example, there is still risk of a human breaking their neck if upside down and they strike the side or bottom of the wind tunnel with any speed. A participant will pay a high cost of about $80 per minute to experience this training method. Lastly, statistics today show that the biggest risk in learning parachuting today is not dying in freefalling into the ground with an unopen parachute, currently about 1 death per year in the United States. Instead, on average 20 to 25 people per year are dying in the United States flying perfectly good parachutes directly into the ground at high speed or angle due to pilot error.

Around the world there are a few marketing products for sale in the parachuting simulator market, but they are large and cumbersome. Systems Technology Inc. (STI) in the United States sells an enormously sized and thus difficult to transport freefall and parachute training simulator named PARASIM. The entry model for sale is an un-customized unit, about the size of an average bedroom, and sells in the $30,000.00+ range. Because of the size and cost, these units cannot be mass produced. The unit is highly proprietary, difficult to setup, and not built with modern and cheap but state of the art commercial-off-the-shelf (COTS) Virtual Reality (VR) equipment. Because of these requirements, the typical user and customer is generally military only.

Low cost and personal video games such as Grand Theft Auto have incorporated limited entertainment aspects of skydiving, or B.A.S.E. jumping (form of parachuting), but these creations are composed entirely of special effects and magic tricks sacrificing realism.

Nevertheless, all the skydiving training and entertainment methods heretofore known suffer from many disadvantages:
(a) High Risk
   While there is no substitute for the real thing, the real thing is high risk. Wind tunnels also are not completely safe.
(b) Expensive Cost
   PARASIM's simulator is $30,000 USD and building a wind tunnel costs $7 Million.
(c) Not Mass Producible
   Prior art simulators are not available to the masses.
(d) Unmarketable
   Current simulators are available to only a select few markets, mostly governmental monopsonies.
(e) Unable to Satisfy Excitement and Growing Skydiving Demand
   Almost everyone would like to try parachuting if their perceived risk is low.
(f) Unable to Train During Bad Weather
   Unable to train students without expensive simulator when it rains or snows, and unable to train students for a night jump.
(g) Heavy Weighted Equipment.
   Current simulators weigh at least 300 lbs.
(h) Difficult to Setup
   Current simulators require thick user manuals and onsite consultation (expensive service contracts).
(i) Difficult to Use
   Current simulators require at least one person to train and are not self-servable.
(j) Unrealistic Aerodynamics More a Game than a Simulation
   Current simulators do not accurately reflect the real aerodynamics and aerodynamics of freefall and parachuting. They do not provide extensible nor accurate models of wind and turbulence, and they game the forces applied to skydivers. They do not support atmospheric densities which vary by altitude. They are often no more than cleverly built and expensive archaic videogames in disguise. Many videogames also exist such as Grand Theft Auto which do nothing than provide more than unrealistic entertainment.
(k) Large Sized
   Current simulators take up at least an average home's bedroom in real estate.
(l) Non-Portable
   Once setup difficult and time consuming to move to another location.
(m) Outdated
   Current simulators uses older and proprietary Virtual Reality equipment. More modern forms are available.
(n) Unrealistic Landing Areas
   Without costly purchase, current simulators do not provide satellite imagery.
(o) Un-scalable Multiplayer
   Current simulators require individual expensive heavy-duty installations at the site of simulation for each individual simulating in a group skydive.

Training to parachute from altitude, or simply enjoying the experience of a skydive, with associates or friends from around the world in any location, can be made less risky, cheaper, and small and portable enough to enjoy in anyone's home or on the go. Satellite imagery and ground level buildings, trees, terrain, elevation, and other detail from providers such as Microsoft, Google or the like bring location and real-world realism to everyone's desktop. Skydiving training can be made less risky to create a more gradual educational program for skydiving students, and less risk will also allow many others who may not want the liability of real parachuting the ability to experience the fun of a realistic skydive. Simulator experts have unsuccessfully tackled airplane flight and numerous flight simulators such as Microsoft's Flight Simulator abound. In addition, previous attempts have failed in incorporating real terrain and/or images that more accurately reflect actual jumps. Further still, previous efforts have also failed to provide simulators that are affordable and portable for skydiving training and entertainment purposes. As such, there exists a need for a more accurate parachute flight simulation that incorporates real terrain in its simulation. There also exists a need for a portable, affordable and low risk skydiving simulation that is easy to setup, is realistic, incorporates realistic landing areas and is scalable.

### SUMMARY OF THE INVENTION

Aspects of embodiments of the present invention contemplate systems, computer program product and computer-implemented methods that enable simulation of authentic/realistic freefall and parachute aeromechanics utilizing, inter alia, portable computing devices, one or more virtual reality head mounted displays, and an input device for user control.

Additional aspects, objectives, features and advantages of the present invention will become apparent from the following description of the preferred embodiments with reference to the attached drawings.

### BRIEF DESCRIPTION OF THE DRAWINGS

FIG. 1A illustrates a system showing user components according to an aspect of an embodiment of the present invention.

FIG. 1B illustrates a head mounted display of the system according to an aspect of an embodiment of the present invention.

FIG. 1C illustrates another head mounted display of the system incorporating a mobile device according to an aspect of an embodiment of the present invention.

FIG. 1D illustrates hand held controller of the system according to an aspect of an embodiment of the present invention.

FIGS. 1E through 1I illustrate the yaw, pitch, and roll of the skydiver bodies and different various aspects of the parachute body as used in aspects of embodiments of the present invention.

FIG. 2A illustrates a system incorporating a harness and a motion sensing input device according to an aspect of an embodiment of the present invention.

FIG. 2B illustrates details of a motion sensing input device of the system according to an aspect of an embodiment of the present invention.

FIGS. 2C through 2G illustrate various poses of a skydiver with a harness and used to initialize an infrared emitter according to an aspect of an embodiment of the present invention.

FIG. 3 illustrates a system incorporating a harness and a motion sensing input device, the user being hung over an opening according to an aspect of an embodiment of the present invention.

FIG. 4 illustrates a parafoil and the various forces that act upon it.

FIG. 5 illustrates the parafoil, the various forces that act upon it, and the angle-of-attack and the chord-tilt angle.

FIG. 6 illustrates the decreasing target landing area available to a skydiver as the skydiver descends under an open parachute.

FIG. 7 illustrates a web application generated perfect spot based upon varying wind speeds and directions at varying altitudes.

FIG. 8A illustrates a main program flow of the parachute flight simulation program according to an aspect of an embodiment of the present invention.

FIG. 8B illustrates a multiplayer thread of the parachute flight simulation program according to an aspect of an embodiment of the present invention.

FIG. 8C illustrates an aeromechanical thread of the parachute flight simulation program according to an aspect of an embodiment of the present invention.

FIG. 8D illustrates an initialization process of the aeromechanical thread of the parachute flight simulation program according to an aspect of an embodiment of the present invention.

FIG. 8E illustrates an exit phase of the aeromechanical thread of the parachute flight simulation program according to an aspect of an embodiment of the present invention.

FIG. 8F illustrates skydive phase of the aeromechanical thread of the parachute flight simulation system according to an aspect of an embodiment of the present invention.

FIG. 8G illustrates a freefall phase of the aeromechanical thread of the parachute flight simulation system according to an aspect of an embodiment of the present invention.

FIG. 8H illustrates a transition phase of the aeromechanical thread of the parachute flight simulation system according to an aspect of an embodiment of the present invention.

FIG. 8I illustrates a paraglide phase of the aeromechanical thread of the parachute flight simulation system according to an aspect of an embodiment of the present invention.

FIG. 9 illustrates a block diagram representation of aeromechanical module of the parachute flight simulation system according to an aspect of an embodiment of the present invention.

FIG. 10 illustrates a more detailed block diagram of aeromechanical module of the parachute flight simulation system along with its constituent subsystems/modules according to an aspect of an embodiment of the present invention.

FIG. 11 illustrates a Wind Subsystem/Module which solves the wind velocities on the parachute flight simulation program according to an aspect of an embodiment of the present invention.

FIG. 12 illustrates a Mass Subsystem/Module which distributes the gravity force on the parachute flight simulation program according to an aspect of an embodiment of the present invention.

FIG. 13 illustrates the first Aero Subsystem/Module which computes the air flow velocities from the space axis coordinates to the body axis coordinates, the angle-of-attack, and the side-slip angle of the parachute flight simulation program according to aspects of embodiments of the present invention.

FIG. 14 illustrates the second Aero Subsystem/Module which computes the skydiver man and parafoil axial, normal, drag, and lift forces of the parachute flight simulation program according to aspects of embodiments of the present invention.

FIG. 15 illustrates the x-Subsystem/Module which accounts for the aerodynamic and gravity forces to compute the acceleration on the skydiver system in the body axis x-direction according to an aspect of an embodiment of the present invention.

FIG. 16 illustrates the z-Subsystem/Module which accounts for the aerodynamic and gravity forces to compute the acceleration on the skydiver system in the body z-axis direction according to an aspect of an embodiment of the present invention.

FIG. 17 illustrates the y-Subsystem/Module which accounts for the aerodynamic and gravity forces to compute the acceleration on the skydiver system in the body y-axis direction according to an aspect of an embodiment of the present invention.

FIG. 18 illustrates the Space Integration Subsystem/Module which solves the overall accelerations, velocities, and positions along the fixed space axes coordinates according to an aspect of an embodiment of the present invention.

FIG. 19 illustrates the Control Line and Bank Angle Subsystem/Module which solves the chord pitch-down angle, and roll (or bank) angle from the skydiver parafoil toggle and front-riser positions according to an aspect of an embodiment of the present invention.

FIG. 20 demonstrates control line and pitch angle control calculation.

FIG. 21 illustrates the resolution of space axes heading angle into geographic heading angle.

FIG. 22 represents the orientation of the space fixed axes versus geographical references.

FIG. 23 represents the space-to-body and body-to-space axes transformation matrices.

FIG. 24 represents the alpha coefficient lookup tables, and the conversion between coefficients of lift and drag to axial and normal force.

FIG. 25 represents the standard atmospheric density table from ARDC 1959.

FIG. 26 represents the solved basic spot “safe-to-jump” over the ground from an airplane.

FIG. 27 is a graph of the simulated typical skydive trajectory Altitude vs. Time with paraglide with the wind.

FIG. 28 is a graph of the simulated typical skydive trajectory Altitude vs. Upwind Distance with paraglide against the wind.

FIG. 29 is a graph of the simulated typical skydive trajectory Crosswind vs. Upwind Distance.

FIG. 30 is a graph of a simulated typical skydive trajectory Altitude vs. Upwind Distance with paraglide with the wind.

FIG. 31 is a graph of a simulated typical spot simple safe exit pattern.

FIG. 32 is a graph of a simulated typical spot simple exit pattern including Sideward Drift Allowance.

FIG. 33 is a graph of a simulated typical spot simple exit pattern with winds in opposite direction including Sideward Drift Allowance converted to geographical coordinates.

FIG. 34 is a graph of an exit pattern.

FIG. 35 is a graph of an exit pattern converted to geographical coordinates.

### DETAILED DESCRIPTION OF THE INVENTION

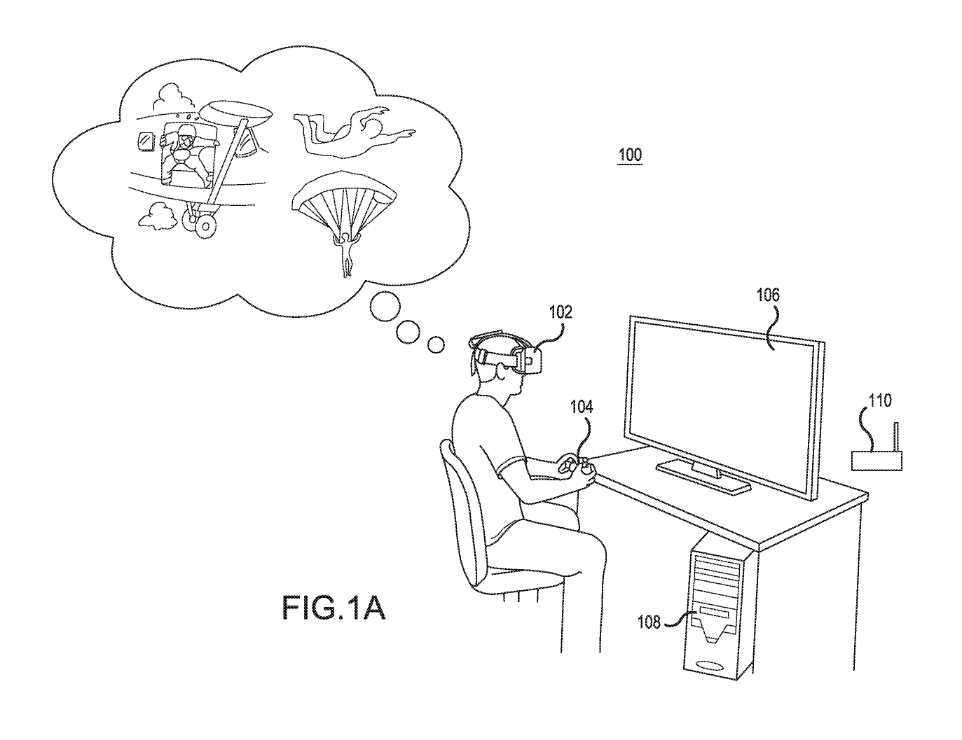

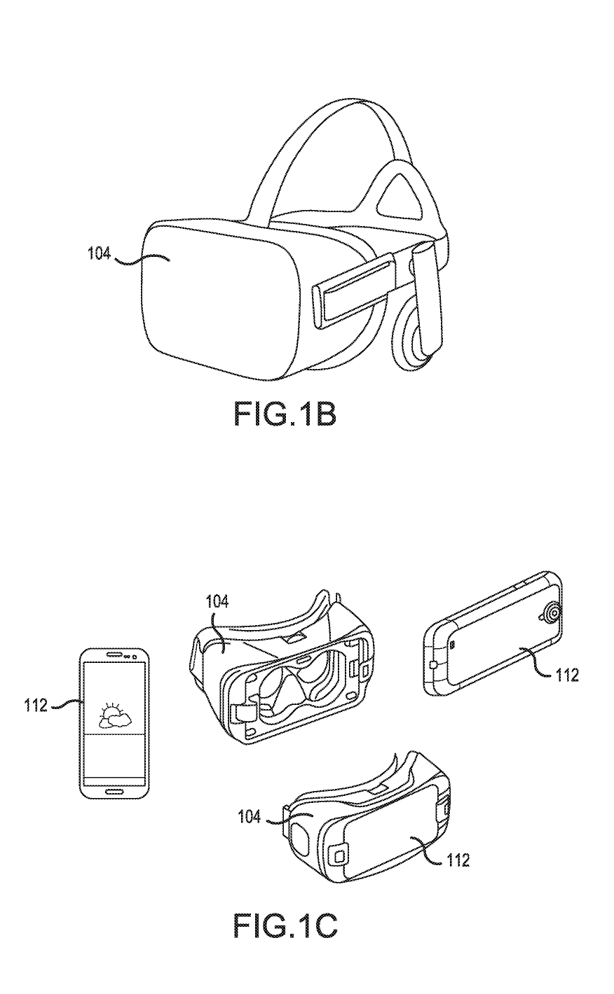

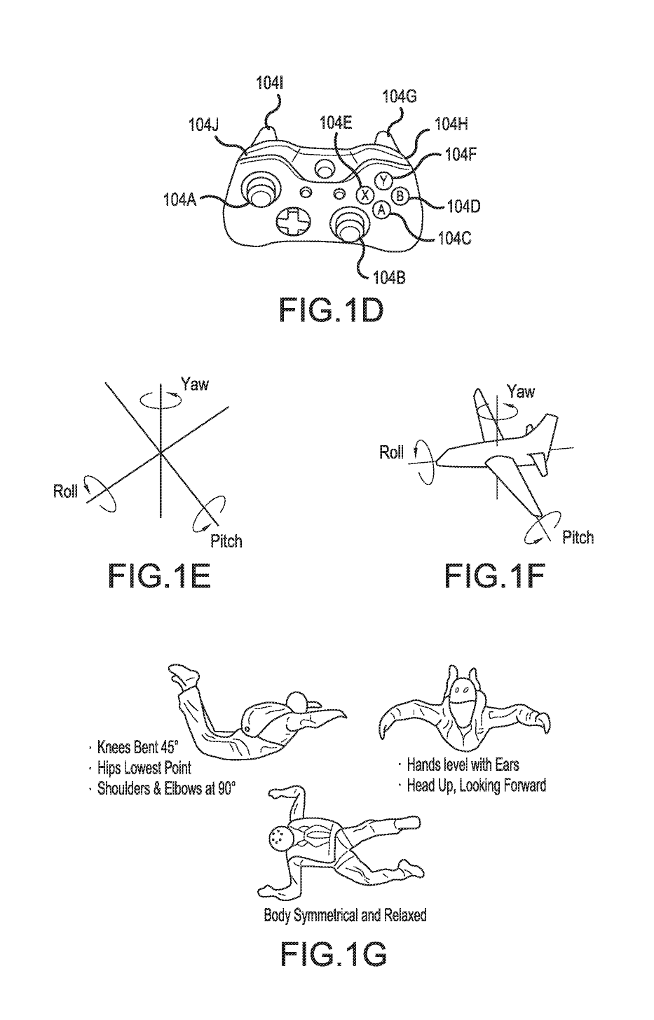

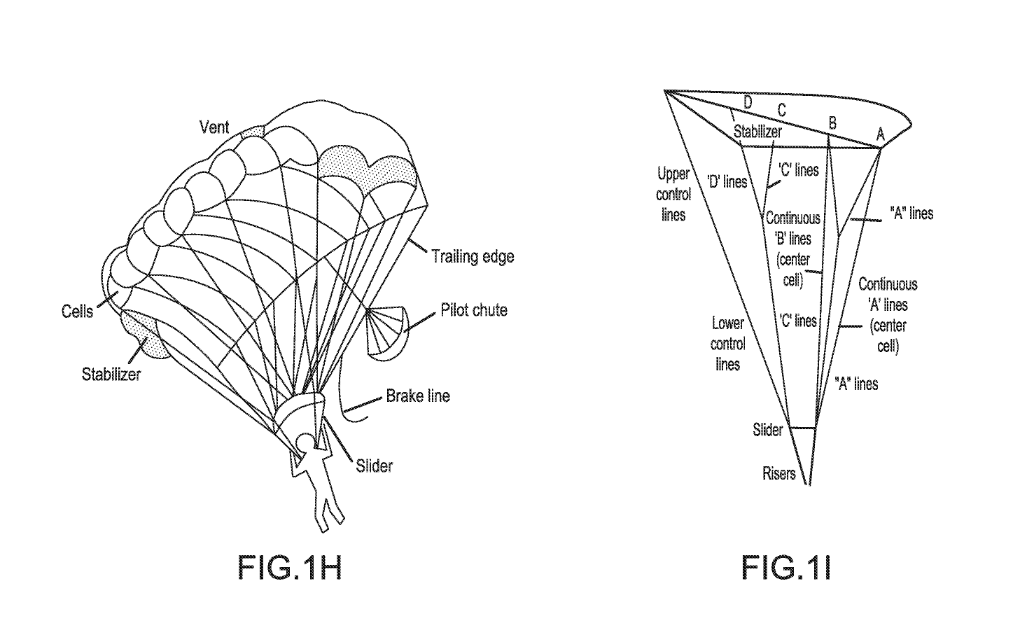

Referring now to FIGS. 1A-3 different components of a parachute simulation system 100 are shown according to aspects of embodiments of the present invention. System 100 may include computer or server 108, display 106, Virtual Reality (VR) Head Mounted Display (HMD) 102, and input controller 104. Additionally, not shown, but to be discussed, application process 800 executing on the server 108. In an aspect of an embodiment of the present invention, system 100 may also include wireless modem 110 for certain wireless applications for components of system 100.

An aspect of an embodiment of the present invention contemplates system 100 being optionally connected to any standard or non-standard Internet connection to dynamically allow a user to jump anywhere in the world, and to allow multiple virtual skydivers to experience a skydive together.

In an aspect of an embodiment of the present invention, computer or server 108 may be a desktop or a laptop computer which can execute and displaying Virtual Reality programs. computer or server 108 may also use a mouse and a keyboard, at least for initial programming and/or operation. Virtual Reality Head Mounted display 102 can be any suitable HMD. In an aspect of an embodiment of the present invention, HMD 102 may have a built-in display. Computer or server 108 may be connected to display 106, usually via various video cables. Computer or server 108 may be connected to Virtual Reality Head Mounted display 102 through a combination of proprietary cables, usually Universal Serial Bus (USB), or wirelessly via wireless modem 110. Virtual Reality Head Mounted display 102 may be plugged into wall outlet power or battery powered. Input controller 104 is usually battery operated and charged via USB cable connected to computer or server 108. Virtual Reality Head Mounted display 102 or input controller 104 may also require some form of wireless setup such as Bluetooth pairing, and calibration to confirm it is working properly. For example, Virtual Reality Head Mounted Display 102 may require staring straight forward in a comfortable head-position to calibrate and acquire the normal looking-forward orientation. Input controller 104 may require moving the joystick left, right, forward, and backward to acquire the normal operating positions.

Computer or server 108 may also include a pre-built 3D game engine such as Unity or Unreal Engine. Using a 3D engine offers many advantages for pre-built ready to use utilities and frameworks that handle: Cartesian coordinate system, transformation between world (space) and object (body) coordinates, cameras and view frustums, vectors and matrices operations, clipping, culling, collision detection, lighting and shading. The 3D engine also enables the user to build a representation of yaw, roll and pitch (FIG. 1E), a 3D model of a designated plane (FIG. 1F), the skydiver's freefalling body (FIG. 1G), the skydiver with a parachute (FIG. 1H), and a parachute (FIG. 1I). In an aspect of an embodiment of the present invention, the user may download pre-built models from different vendors. These models may then be saved within the 3D game engine's folder. The user may then attach a virtual reality camera such as OVRCamera to the skydiver body and skydiver with the parachute.

System 100, according to one aspect of an embodiment of the present invention, along with its attendant software, hardware and components are used to enable simulation of straight flight and turning flight. One software component, according to an aspect of an embodiment of the present invention, contemplates having the user or trainee sky diver remaining vertical to simulate (and displayed to the user) straight flight while another software component contemplates having the user tilt off the vertical during turning. Additional aspects of embodiments of the present invention contemplate simulations of any one or a combination of: toggle turning, front riser turning, front riser diving, stalling—where each or all are simulated and displayed to the user by use of software component(s) of the system.

Once all the required connections are in place, the user may operate the simulation. The user dons Virtual Reality Head Mounted display 102, operates the computer (via an operating system such as Windows), navigates to the folder where the executable file resides, and executes the parachute simulation application by double clicking the executable file created. In an aspect of an embodiment of the present invention, the parachute flight simulation program may be downloaded over the Internet. Once downloaded, the user may click a button on controller 104. The user may click another applicable button on controller 104 (or any desired mapped button) to end their freefall or start the parachute deployment and descent. The user may push or pull the left thumbstick or right thumbstick on controller 104, or any joystick down or toward their body to effectively pull their parachute toggles down.

In an aspect of an embodiment of the present invention, the user, after setting the Virtual Reality Headset on their head, is given a list of choices on the display. In an aspect of an embodiment of the present invention, the Virtual Reality Headset may be used with an additional Display on a Desktop or Laptop Computer, or the Mobile Phone may be the Display for the Virtual Reality Headset. The system enables aa user to visually see and select, using the Controller(s), a GPS location where they choose to jump. Optionally, the user may see a choice of canopies, and selects their canopy performance characteristics such as parachute size, number of cells, dimensions, or a preconfigured and established parachute brand. The user may also choose default, random, or low wind conditions. The user may additionally choose whether or not to jump with other jumpers by sharing a mutual password. Finally, the user selects the option to Jump. The user is in the airplane, looking over a drop zone, and gives the command to exit. The user opens their parachute when they choose. The user turns their head to see the view in any direction, and uses their hands to pull the parachute toggles and thus steer over and to the landing area, and finally flare their toggles to land.

There are various possibilities regarding both the Head Mounted display 102 and input controllers 104 which may be used. An aspect of an embodiment of the present invention also contemplates a Head Mounted display 102 configuration which is comprised of a mobile device 112 used along with HMD 102. The application may be developed on computer or server 108 and computer display 106, and tested partially there, but fully tested and deployed to mobile device 112 which uses the lenses inside of HMD 102. Mobile device 112 may plug into HMD 102 as shown in FIG. 1C.

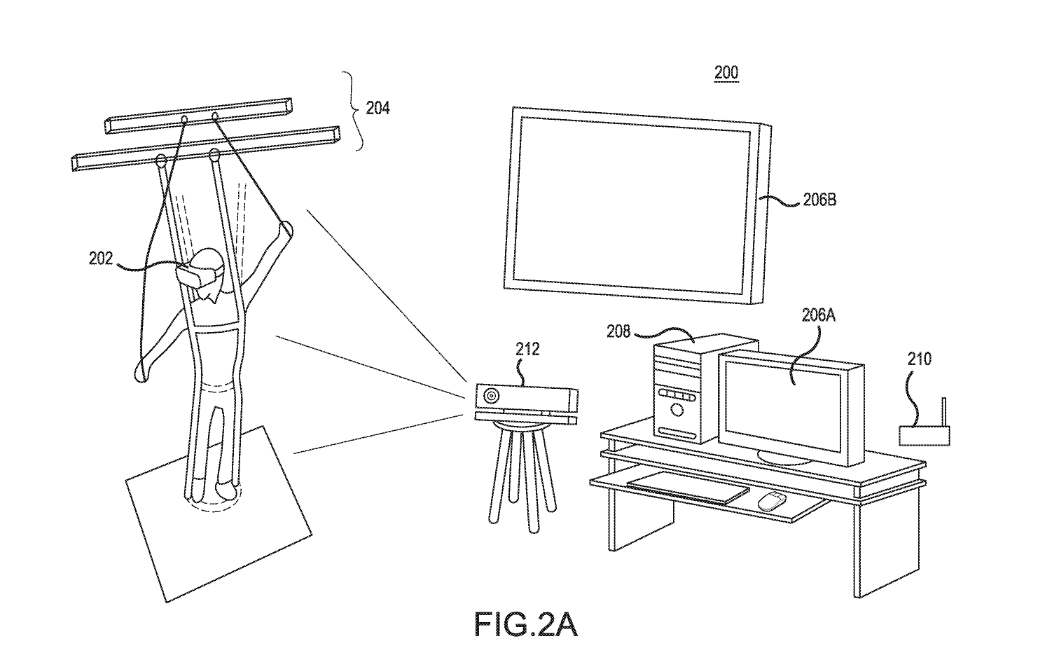

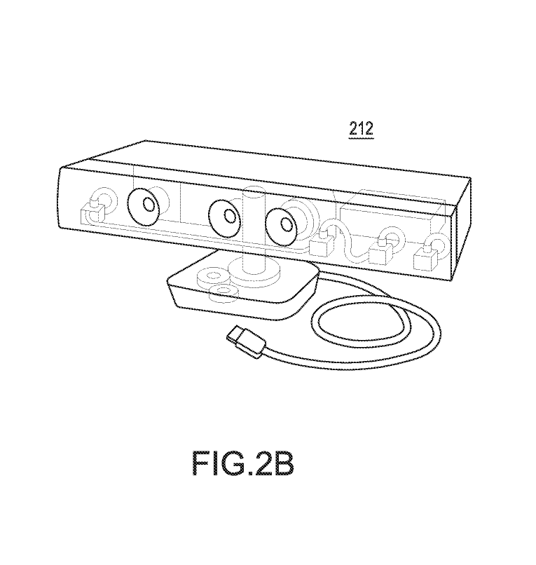

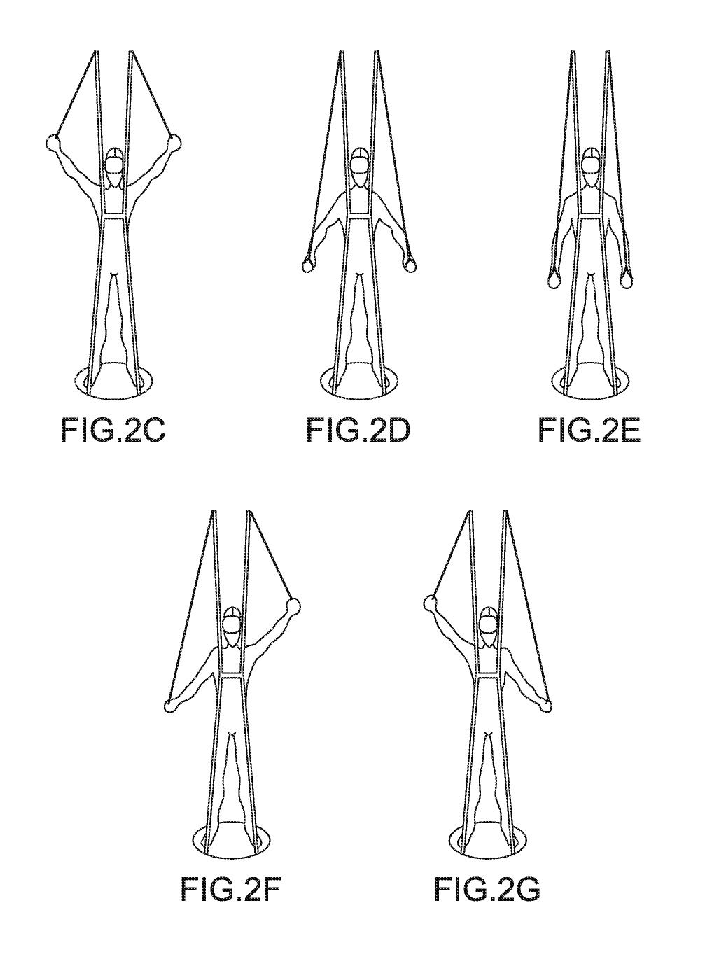

Referring now to FIG. 2A through 2G, a system 200 incorporating harness 204 and motion sensing input device 212 along with user harness poses are all shown according to aspects of embodiments of the present invention. Here, a completely hands-free alternative embodiment is enabled. Optional harness 204 may be worn by the user to enhance the realism of the experience. The user can be leaning against a harness fastened to ground and the ceiling, or the user can be suspended in a hanging harness from the ceiling. The hands-free operation may be achieved by using motion sensing input device 212 such as Microsoft Kinect or the like. Motion sensing input device 212 may be connected with computer or server 208 with all proprietary connections. The hands-free operation uses an infrared emitter to see the skydiver in 3D, and passes skeleton joint x, y, z information back to the computer program to determine the hand positions. Initialization of motion sensing input device 212 may entail placing motion sensing input device 212 5-10 feet in front of the user and have the user stand alone in front of motion sensing input device 212. The user raises their hands above their head, and pulls their arms down to turn or flare the parachute. The user may also use voice or other hand gestures to provide direction to the parachute simulation. These different poses are shown in FIGS. 2C through 2G. With each pose, motion sensing input device 212, during initialization of device 212, records each pose and the user may define the pose for device 212. This enables device 212 to determine and translate a certain pose by the user during the parachute flight simulation.

An additional aspect of an embodiment of the present invention contemplates any of the above previously mentioned aspects but additionally includes an ability for a Building, Antenna, Span, and Earth (acronym of BASE) jumper to practice or train for a real BASE jump. This primarily involves jumping from a Building, Antenna, Span, or Earth position instead of exiting an aircraft, plane, or satellite.

An additional aspect of an embodiment of the present invention contemplates any of the above previously mentioned aspects but additionally includes an ability to replay a real skydive from recorded earth positional (Global Positioning System GPS) and/or orientation, or attitude (yaw, pitch, roll) information. The Flysite company in New Zealand provides recorded GPS skydives in a file format where each record in the file comprises of a different geographical position, which is easily read and rendered in Virtual Reality using system as contemplated in aspects of embodiment of the present invention. The embodiment could represent a military, tandem, or other skydive passenger who exits an airplane or BASE jump, and relives their experience in Virtual Reality via one of the above means.

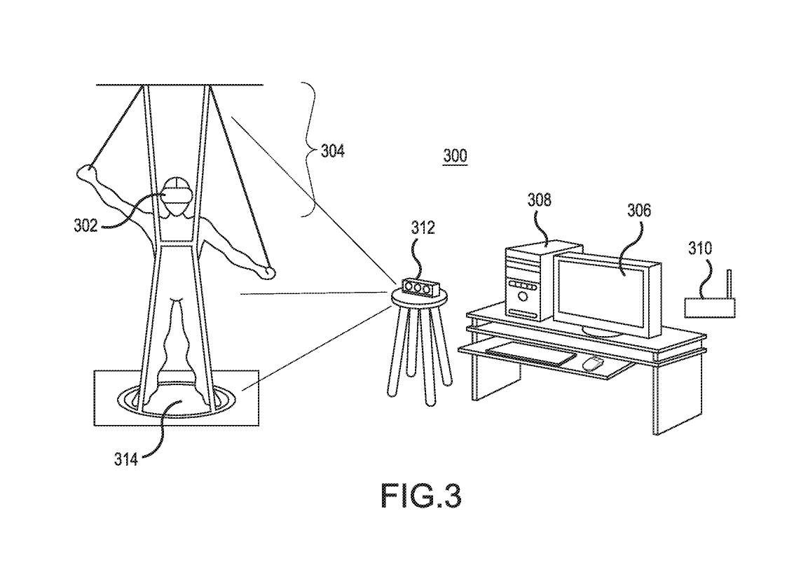

Referring now to FIG. 3, a system 300 incorporating a harness 304 and a motion sensing input device 312, with the user being hung over an opening 314 is shown according to an aspect of an embodiment of the present invention. Here, as with the previous aspect, a completely hands-free alternative embodiment is enabled. Optional harness 304 may be worn by the user to enhance the realism of the experience. The user can be leaning against a harness fastened to ground and the ceiling, or the user can be suspended in a hanging harness from the ceiling with opening 314 providing added feel for the user. The hands-free operation may be achieved by using motion sensing input device 312 such as Microsoft Kinect or the like. Motion sensing input device 312 may be connected with computer or server 308 with all proprietary connections. The hands-free operation uses an infrared emitter to see the skydiver in 3D, and passes skeleton joint x, y, z information back to the computer program to determine the hand positions.

Aspects of embodiments of the present invention contemplate an aeromechanics program that is a six degrees-of-freedom parafoil trajectory simulation computer program designed to train skydivers to control and accurately navigate the parafoil from deployment to landing.

The program consists of a three-dimensional trajectory in Cartesian fixed space coordinates X̅,Y̅,Z̅, which is readily transformed into the geographic coordinates latitude, longitude, and altitude. The skydiver system consisting of the skydiver and parachute are assigned the body-axes x,y,z to account for its attitude in space. The attitude is given by the three Euler angles, yaw (or heading) (ψ), pitch (θ), and roll (or bank) (φ), of the body axes, relative to the fixed space coordinates.

The forces due to gravity, aerodynamic lift, and aerodynamic drag are solved for the skydiver body and the parachute in terms of the body-axes x,y,z coordinates. For each computer time increment, Δt, these forces are divided by the skydiver and parachute masses to provide an acceleration along each x,y,z coordinate. Then the resulting body-axis accelerations \ddot{x}, ÿ, \ddot{z} are transformed back to the space coordinates to form the accelerations in the space coordinates as \overline{\ddot{X}}, Ÿ̅, \overline{\ddot{Z}}. These accelerations are then timewise integrated a first time to obtain the space velocities \overline{\dot{X}}, \overline{\dot{Y}}, Ż̅, and a second time to obtain the space positions X̅,Y̅,Z̅. These positions are transformed to the geographic coordinates latitude, longitude, and altitude.

The aerodynamic forces are solved as functions of angle-of-attack alpha (α) and side-slip angle beta (β) on the skydiver body and the parachute. Gravity force is always directed in the negative direction Z̅ (downwards). Trigonometry is used to relate the skydive system body-axes x,y,z to the space-coordinates X̅,Y̅,Z̅ to obtain the roll (or bank) (φ), pitch (θ), and yaw (or heading) (ψ) angles.

Flight experience and modern parafoil design indicates that the skydiver faces along the horizontal component of the velocity vector. The skydiver system x-coordinate is always along the changing direction of travel given by the horizontal component of the velocity vector in the space-coordinates. The yaw (or heading) ψ angle is solved by timewise integrating Δψ over the Δt computer time intervals according to:

$$Δψ = {cos}^{- 1} ( \frac{{v}_{1}^{2} + {v}_{2}^{2} - {w}^{2}}{2 {v}_{1} {v}_{2}} )$$

$$where$$

$${w}^{2} = Δ {\dot{{X}_{\_}^{\_}}}^{2} + Δ {\dot{{Y}_{\_}^{\_}}}^{2}$$

$${v}_{1}^{2} = {\dot{{X}_{\_}^{\_}}}_{1}^{2} + {\dot{{Y}_{\_}^{\_}}}_{1}^{2}$$

$${v}_{2}^{2} = {\dot{{X}_{\_}^{\_}}}_{2}^{2} + {\dot{{Y}_{\_}^{\_}}}_{2}^{2}$$

The bank or roll angle, φ, is given by the differential toggles control lines lengths.

The pitch angle, θ, is given by the joint toggles control lines lengths after allowance is made for the parachute rigger's pre-set pitch angle, θ₀.

The system as contemplated by aspects of embodiments of the present invention realistically replicates parachute flight performance over the ground taking into account wind conditions. This cycle of assessing wind conditions, interpretation and decision while under canopy is a basic required skill of all skydivers. This skill of decision making under canopy can also be viewed as navigation. Therefore, aspect(s) of embodiment(s) of the present invention take into account different input variables associated with modern parachutes. Input values to the computer program may include the following: parafoil design information (span, chord lengths, line lengths), skydiver height and weight, shoulder width, arm length, atmospheric density vs. altitude profile, atmospheric wind direction and speed vs. altitude profile, parachute opening altitude, velocity, air density (related to temperature and altitude above sea level), different types of parachute information, parachute drag, speed when not turning (vertical and horizontal feet per second) taking into account wind conditions and the direction the parachutist is flying at the time, speed during a toggle turn (vertical and horizontal feet per second) taking into account wind conditions and the direction the parachutist is flying at the time and speed when using front risers to induce a turn (vertical and horizontal feet per second) taking into account wind conditions and the direction the parachutist is flying at the time.

The main skydiver control input is the toggle control. Both arms raised at near full extension forward and above the head constitute the standard glide optimum position. This position above the head constitutes a maximum normal glide descent rate. Pulling down on the front risers causes a steep dive. Lowering the toggles from the head-high position creates an increased angle-of-attack on the parachute leading to a flaring of the chute; and in the limit a stall for final landing. A right toggle down causes a right bank and turn. A left toggle down causes a left bank and turn. The toggle positions are controlled by the Virtual Reality System as well as for the forward front risers for a deep dive. This is implemented in the computer program by allowing for the respective line lengths of the parafoil.

In summary, skydiver training is exemplified on a computer with the Virtual Reality System (VRS) inputs representing the parafoil toggles, as well as the front risers for steep dives. The VRS represents control of the line lengths of the various parachute risers. System parameters such as the parafoil design, skydiver characteristics, initial deployment conditions, atmospheric density, wind profiles, and aerodynamic tables are input to the computer program prior to its start. Default values are in the program and can be overwritten as desired. The computer screen can present the flight-time profile of the trajectory, including the velocities, accelerations, and pitch, yaw (heading), and roll (bank) angles, as well as issue stall warnings. Warnings of inadequate, ram air pressure for parachute inflation are also provided.

Aspect(s) of embodiment(s) of the present invention enable the upload and use of previous jumps which were undertaken with very accurate data collection devices which use GPS satellites to define their exact location (which track, many times per second, data on altitude, longitude/latitude, direction and velocity). Such data points may be uploaded into the contemplated system resulting in the ability for continuous improvement of the system. Aspects of embodiments of the present invention also has integrated into its web application the ability for a user to upload their own flight data and/or parachute performance data. This data is used to compare actual to calculated subsequently improving the results of the system.

Aspect(s) of embodiment(s) of the present invention enable the web virtual reality version of system 100 to respond to a user's selection on location. This means a user can select a relevant location for their virtual parachute descent. This enables the user to experience a virtual rendition of an actual drop-zone.

Spotting is the name of the skill in skydiving to assess wind conditions, ground speed and direction of the aircraft together with parachute performance to judge when to exit with the goal of landing back at the landing zone. A good spot is that area of the earth's surface which when exited over allows the skydiver to land back on the landing zone. When parachutists land off the landing area they are statistically more susceptible to injury (landing on power wires, in trees, falling off the roof of a house, being attacked by a bull elk etc.). With larger aircraft now being used at many drop zones, the skill of spotting is declining amongst skydivers. Some skydivers simply cannot spot as they have jumped all their skydive career at drop zones where the pilot does the spot and communicates to the skydivers on board it is safe to jump by switching on a green light above the exit door then switching it off when it is not safe to jump. Add to this scenario new disciplines in skydiving which have different fall rates which may use different amounts of airspace. Spotting now includes allowing for and accommodating for separation of different groups of skydivers doing different disciplines (each type of group has different fall rates and airspace requirements). Spotting now needs to give adequate distance between these different groups for safety when it comes to opening a parachute.

Given this backdrop, an aspect of an embodiment of the present invention provides for a robust system that enables customization to properly calculate the spot and separation between groups using the following parameters: 1) Exit altitude above ground level, 2) Airspeed of aircraft), 3) Parachute opening altitude above ground level, 4) Landing area height above sea level, 5) Jump plane ideal direction in nil winds, 6) Declination—difference between true north and magnetic north, 7) User can use forecast winds, 8) User can customize winds speeds and directions 9) The parachute performance is that of a 160 sq. foot reserve parachute with a 200 lb exit weight, 10) Is fully open and operational at 2000 feet above ground level, 11) Has a glide ratio of 2.06 to 1, 12) Chord tilt angle of 17.8 degrees in straight and level flight.

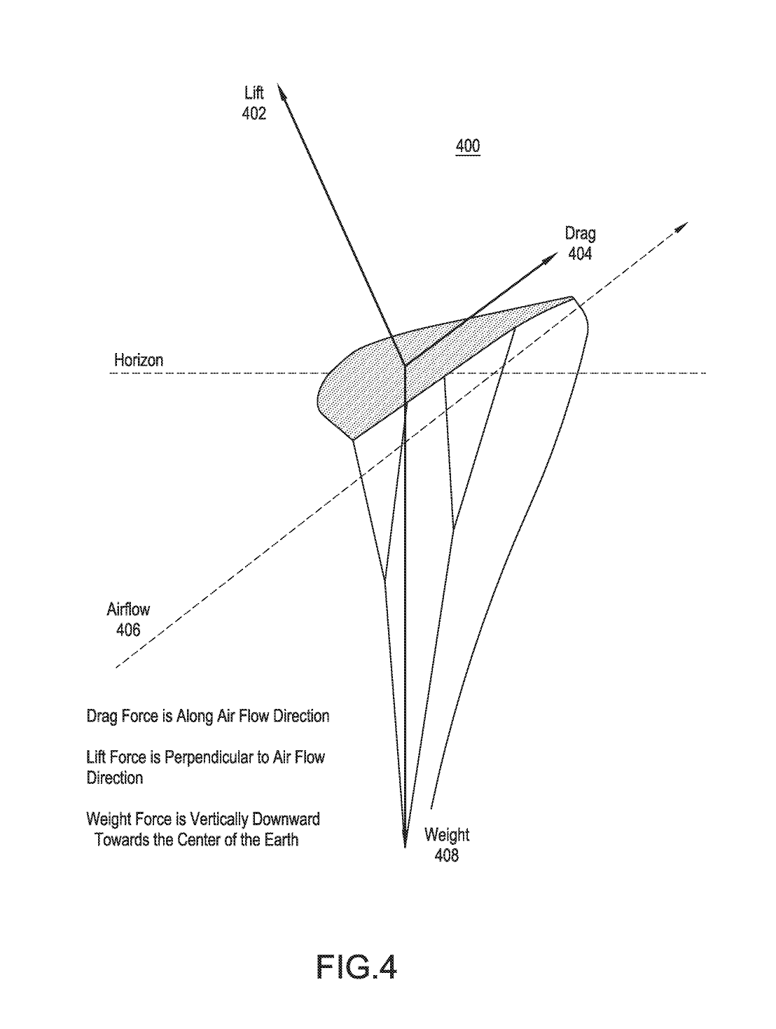

Referring now to FIG. 4, a parafoil 400 and the various forces that act upon it are shown for illustrative purposes. Parafoil 400 may have a number of forces acting upon it such as lift 402, drag 404, airflow 406 and weight 408. Drag force 404 is along the air flow direction, while lift force 402 is perpendicular to the airflow direction. Weight 408 is vertically downwards towards the center of the Earth. These forces are illustratively shown as background for later discussion of aspects of embodiments of the present invention.

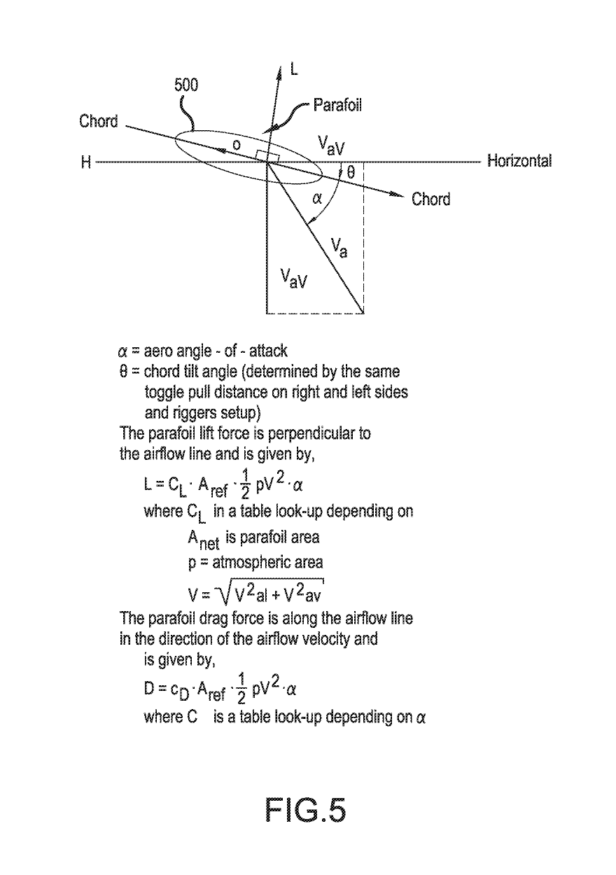

Referring now to FIG. 5, a parafoil 500 is shown with the various forces that act upon it along with the angle-of-attack and the chord-tilt angle. As shown,
α=aero angle of attack
θ=chord tilt angle as determined by the same toggle pull distance on right and left and riggers setup.

The parafoil lift force is perpendicular to the airflow line and is given by,

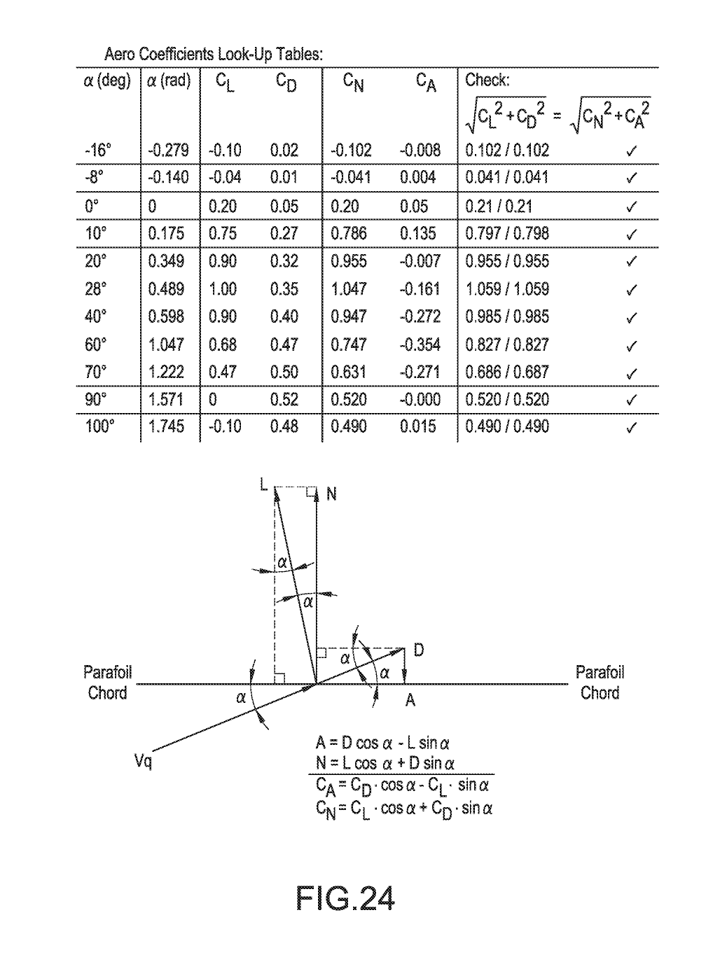

L=C_{L}·A_{ref}·½ρV²·α

where C_{L} is a table look-up depending on α (see, FIG. 24)
A_{ref} is the parafoil area
ρ is the atmospheric density and

V=√((Vₐₕ)²+(Vₐᵥ)²)

The parafoil drag force is along the airflow line in the direction of the airflow velocity and is given by,

D=C_{D}·A_{ref}·½ρV²·α

where C_{D} is a table look-up depending on α.

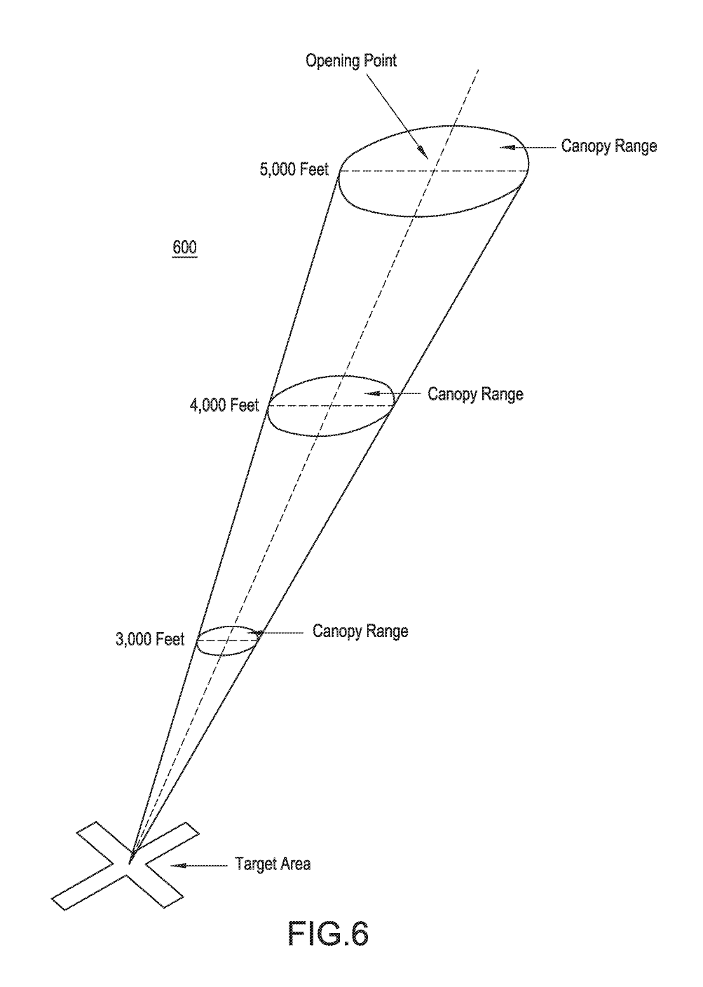

Referring now to FIG. 6, the decreasing target landing area available to a skydiver is shown as the skydiver descends under an open parachute. As shown, the canopy range for the skydiver decreases as the skydiver descends from 5000 ft to 4000 ft to 3000 ft.

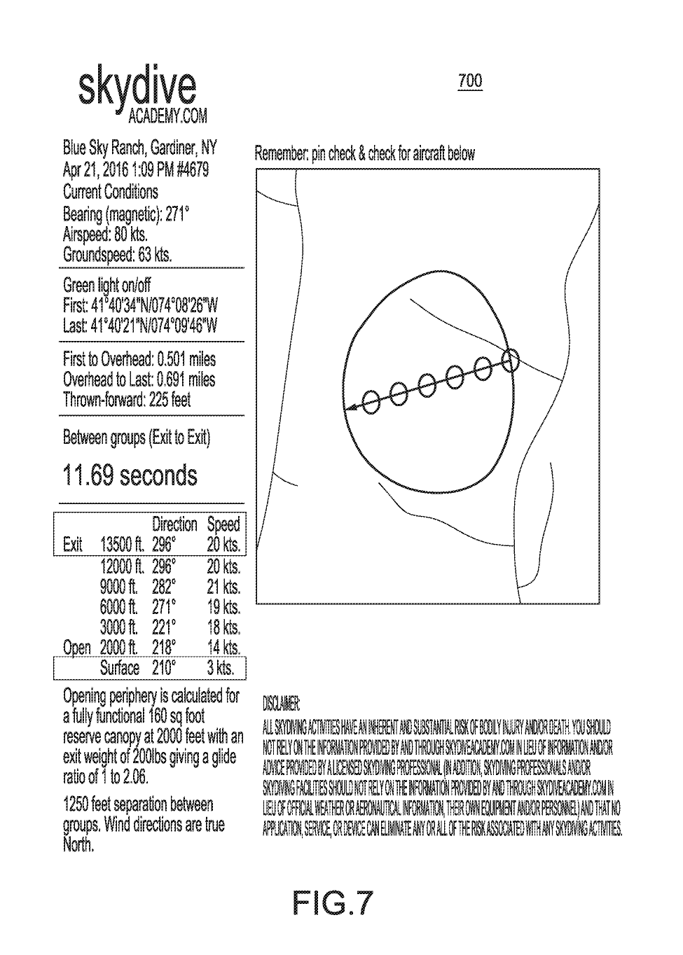

Referring now to FIG. 7 a web application generated perfect spot based upon varying wind speeds and directions at varying altitudes.

Aspects of embodiments of the present invention contemplate the use of modules in implementation of the process(es) outlined herein and operation of components of the system also disclosed herein. In an aspect of an embodiment of the present invention, the term “module” may represent self-contained computer hardware such as electronic circuits packaged on hardware such as a circuit board to provide a basic function. In another aspect of an embodiment of the present invention, the term “module” may represent computer hardware on a designated computer chip or separate computer chips. In a further aspect of an embodiment of the present invention, the modules may be hardware resident on one chip, component, separate components, a server or processor, database, or any combination thereof. In one aspect of an embodiment of the present invention, the processor may be configured to coordinate, implement and/or assign tasks to, from and/or among the module(s). In a further aspect of an embodiment of the present invention, module components may also, in an operational context, be components of other modules. These modules are components of server 108 which may be configured to perform a predefined set of basic operations in response to receiving a corresponding basic instruction selected from a predefined native instruction set of computer executable codes. The modules then may include a set of machine codes selected from the native instructions set of the server 108 in order to perform specific functions and/or operations.

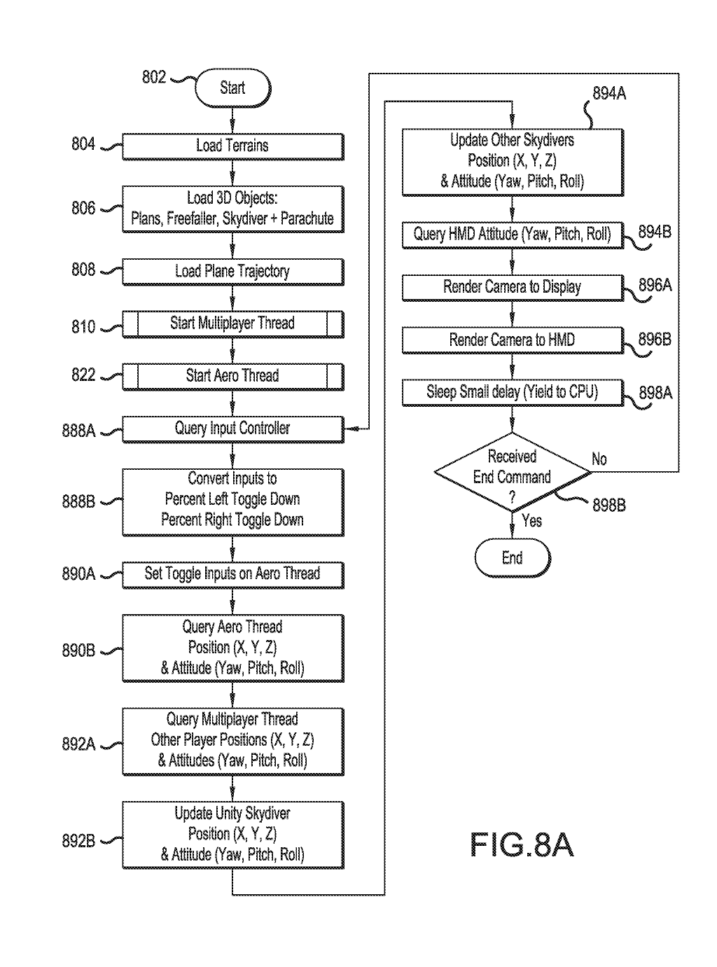

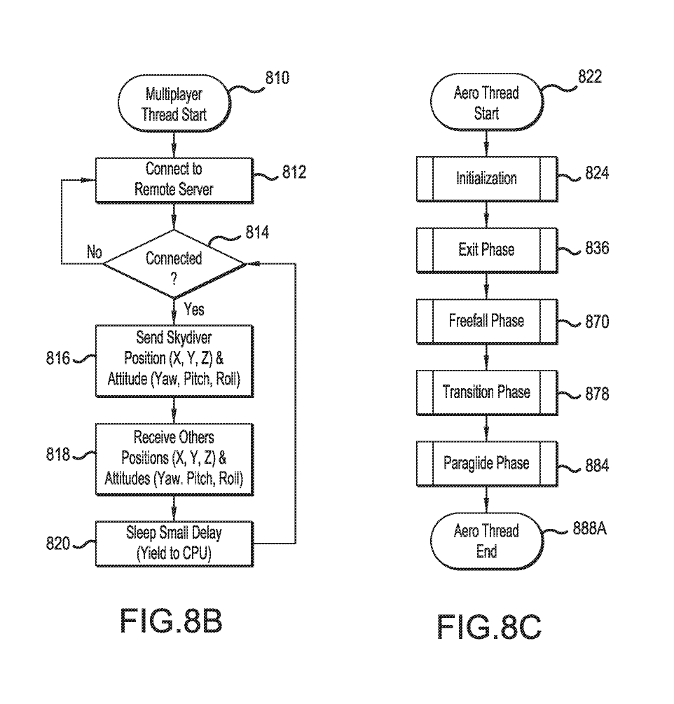

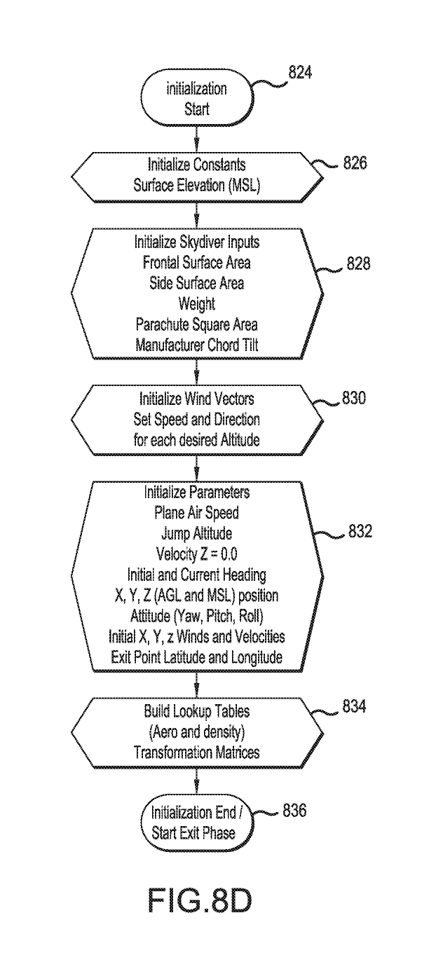

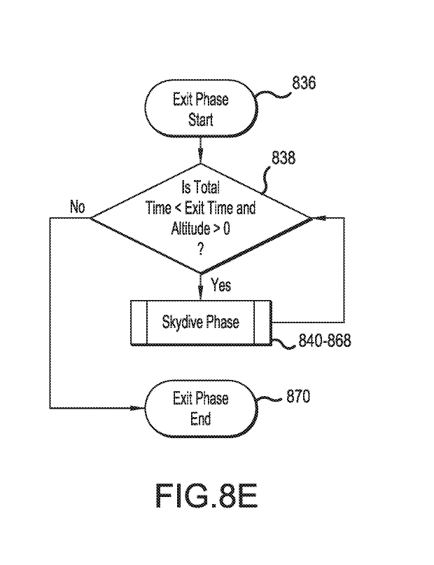

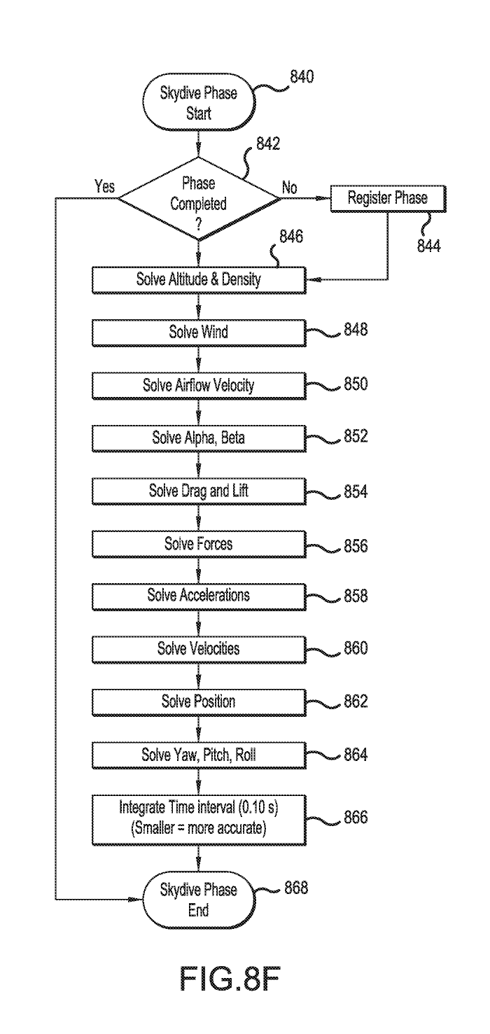

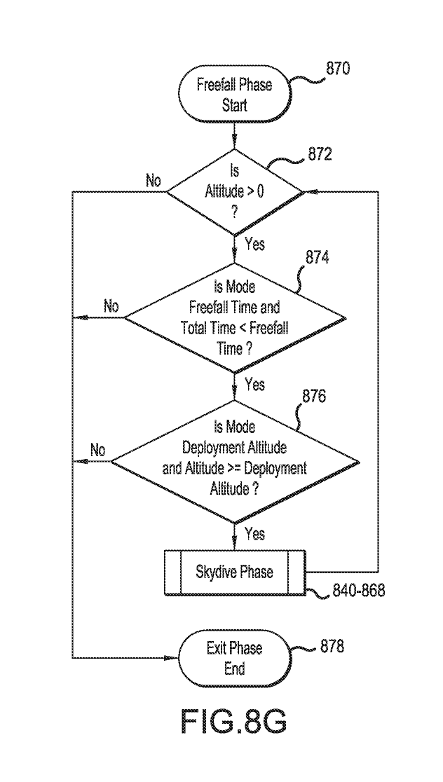

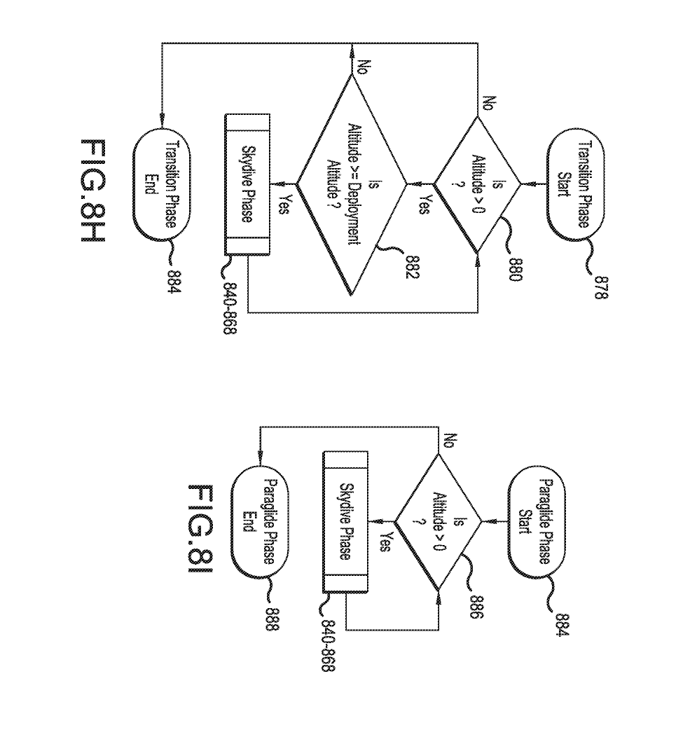

Referring now to FIG. 8A main program flow 800 of the parachute flight simulation program is shown according to an aspect of an embodiment of the present invention. Once the user has set up system 100, the parachute flight simulation program or process begins with step 802 which proceeds to step 804 where a loading module of server 108 enables the loading of realistic terrains onto data structures of server 108. Such terrains may include satellite imagery, ground level buildings, trees, terrain, elevation, realistic mountainous terrain, virtual custom make-believe landing area and other topographic detail or a combination thereof. Next, in step 806, the loading module enables the loading of 3D objects onto data structures of server 108. These objects may include: the plane the skydiver exits from, the freefalling body of the skydiver, and the skydiver under his open parachute (two 3D objects linked together) such as those shown in FIGS. 1E through 1I. Next, in step 808, the loading module enables the loading of the skydiver's plane trajectory onto data structures of server 108. The process then proceeds to steps 810 and 822 where two separate threads, the Multiplayer thread, and the Aero thread, are started which execute separately from the thread in the main program process 800. In an aspect of an embodiment of the present invention, these threads may be executed sequentially. In another aspect of an embodiment of the present invention, server 108 may multitask and switch between the threads of execution (while each is processed in separate loops).

Referring now to FIG. 8B, the multiplayer thread of the main parachute flight simulation program 800 is shown in detail according to an aspect of an embodiment of the present invention. Execution of the multiplayer thread entails execution of a multiplayer module and starts at step 810. The process proceeds to step 812 where the multiplayer module connects with a remote server, such as a Photon cloud. The process proceeds to decisional step 814 where the multiplayer module determines whether it is still connected to a remote server. A negative determination takes the process back to step 812 where the module reconnects with the remote server. An affirmative determination (of step 814) leads the process to step 816 where the multiplayer module sends the current skydiver's position and attitude information to server 108, and, in step 818, receives the positions and attitude information which are broadcast by the multiplayer game server of other skydivers' positions. This information can be queried by the main parachute flight simulation program 800. Next, the process proceeds to step 820 where the thread yields the CPU to the Operating System to perform other tasks for a certain predetermined time before leading the process to step 814 for a repeat of the multiplayer thread.

Referring now to FIG. 8C an aeromechanical thread of the main parachute flight simulation program 800, is shown according to an aspect of an embodiment of the present invention. The aeromechanical thread, a result of execution of an aeromechanical module, may be executed once to solve a valid spot over the ground from which the skydiver may safely jump, and it will be executed again to allow the skydiver to jump and visually simulate and fly the skydive and parachute trajectory back to the ground with real inputs of the skydive freefall, and real toggle and front riser inputs to the parachute body. It consists of an Initialization phase, followed by the four normal phases of a skydive: the Exit Phase, the Freefall Phase, the Transition Phase, and the Paraglide phase.

The aeromechanical thread starts at step 822 which proceeds to initialization phase in step 824 as detailed in FIG. 8D. Referring now to FIG. 8D, the initialization phase begins with step 824 before proceeding to step 826 where certain inputs and data points are initialized or entered. These inputs and data points are shown in FIG. 8D and discussed in detail below.

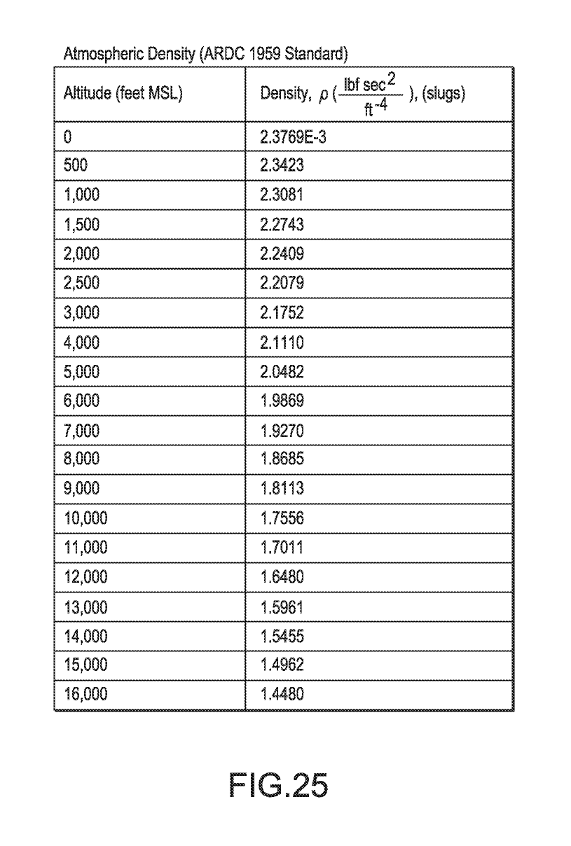

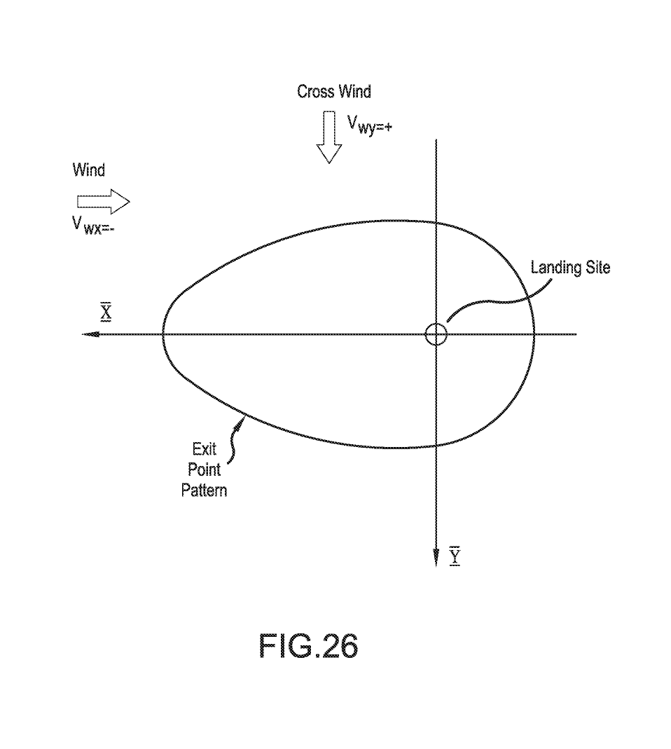

The Initialization Phase starts by initializing constants for the local Surface Elevation (MSL) (step 826), skydiver inputs frontal surface area (height by width), side surface area (height by width), skydiver weight in pounds, parachute area in square feet, and manufacturer's chord tilt angle (step 828). Next, wind vectors of both speed and direction are set in step 830 at all desired altitudes of the skydive from altitude to ground. Following step 830, in step 832, the plane air speed over the ground is set, the initial exit (jump) altitude, the initial z velocity before exiting the airplane is set to 0.0, the initial heading and current heading are set to geographical angle (0 degrees for North, 180 south, etc.), the current X, Y, Z position and orientation, or attitude (yaw, pitch, roll) of the plane exit. The current X, Y, Z may be found from geographical coordinates at any time by solving for them as described in Conversion of Trajectory Space Coordinates to Geographic Coordinates. Next in step 834, the coefficients of drag and lift/normal and axial forces, and air density lookup tables shown in FIG. 24 (Forostoski, Riley, Vaillancourt, & Wilfong, 2006) and FIG. 25 (Minzner, Champion, & Pond, 1959) are populated within data structures of the memory for fast access by the remainder of the program. The initial total time of the skydive is set to 0.0 seconds, and accumulates in real time as the skydive progresses by an integration time interval. The smaller the time interval is, the more accurate the skydive trajectory will be, but also the great computing power required. The larger the time interval is, the less accurate the skydive trajectory and realism will be, but also less computing power required. For current personal computers, we find a time interval of one tenth of a second, or 0.10 seconds, is appropriate. At each step of the initialization phase, the data inputs are used to populate data structures for reference points and for access by the process 800. Following population of the data structures in step 834, the process ends and proceeds to step 836 signaling the start of the Exit phase.

Referring now to FIG. 8E an exit phase of the aeromechanical thread of the parachute flight simulation program 800 is shown according to an aspect of an embodiment of the present invention. The exit phase begins at step 836 and proceeds to decisional step 838 where a determination is made as to whether valid exit condition has occurred. This is done by determining whether the total time is less than the exit time and the altitude is zero. An affirmative determination of decisional step 838 then leads the process to the skydive phase of steps 840-868 (as described below). A negative determination leads to the end of the exit phase and start of the freefall phase in FIG. 8G.

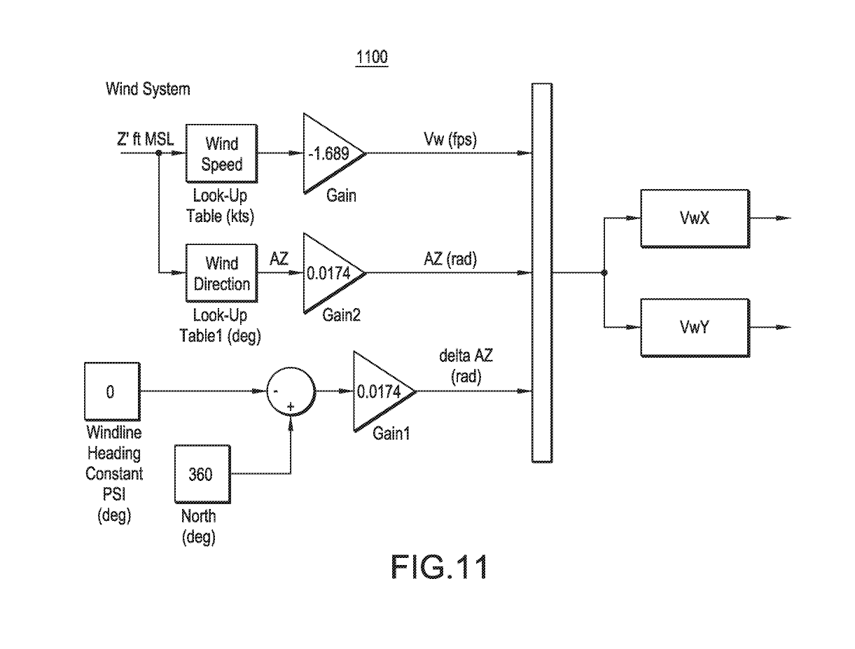

Referring now to FIG. 8F the skydive phase of the aeromechanical thread of the parachute flight simulation program 800 is shown according to an aspect of an embodiment of the present invention. The skydive phase begins at step 840 and proceeds to decisional step 842 which determines whether he skydive phase has been completed. An affirmative determination leads to step 868 where the skydive phase ends while a negative determination leads to step 846 where the altitude and density is solved. The solutions shown in the skydive phase are implemented by execution of different modules for different determinations. The block diagrams of each relevant module or subsystem are shown and referred to in FIGS. 11, 13, 14, 15, 16, 17, 18, and 19. The discussion for each module is also discussed here.

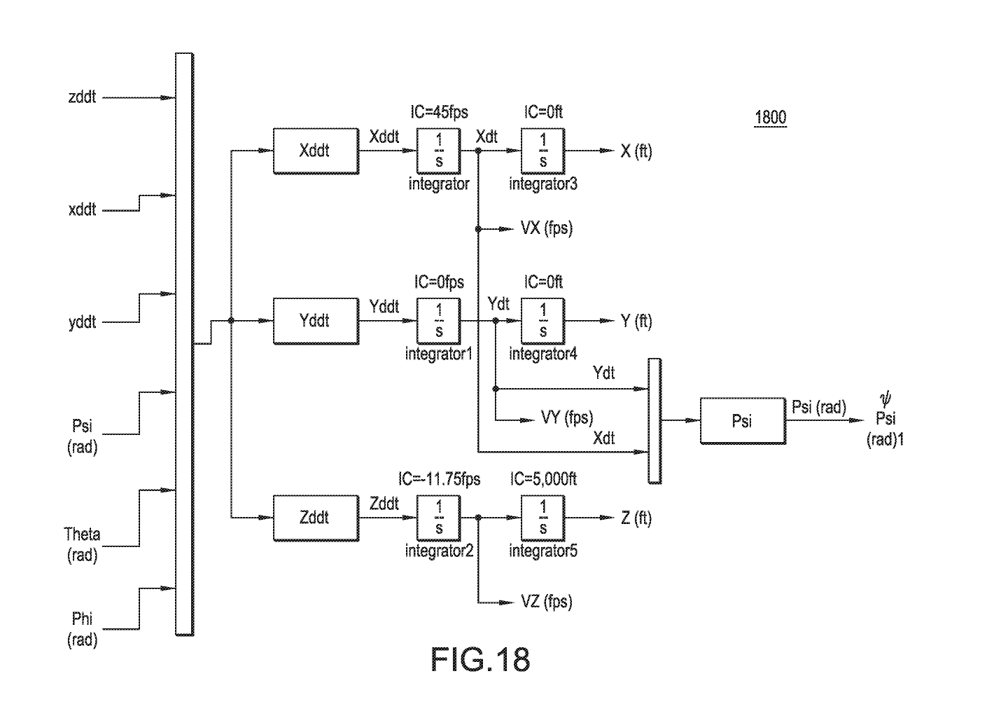

Following the determination that the skydive phase has not been completed, the skydive phase proceeds to step 846 where the space integration subsystem or module 1800 (FIG. 18) determines or solves the altitude and density. Here, data look-up tables are provided for windspeed and direction vs. altitude, air density (ρ) vs. altitude, parafoil drag and lift coefficients vs. angle-of-attack (α). Equations are used for the skydiver body drag and lift vs. angle-of-attack (αₘₐₙ).

Inputs to space integration subsystem or module 1800 include the accelerations along the body-axes (\ddot{x}, ÿ, \ddot{z}) and the three Euler angles heading (ψ), pitch down (θ), and bank-angle (φ).

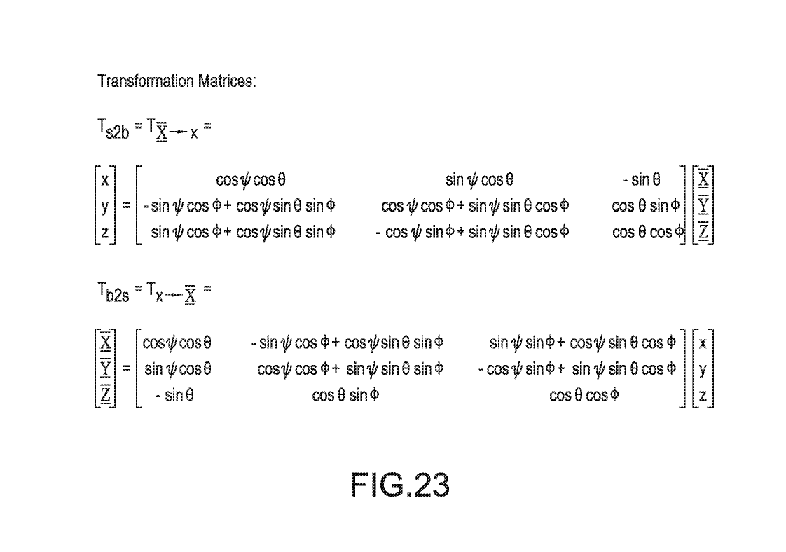

The space-axes accelerations are computed from the body-axes accelerations by the transformation matrix τ_{bls} (see, FIG. 23). This matrix is a trigonometric coordinate transformation matrix from space coordinate velocity values to skydiver body coordinates. It is based on the three Euler angles between the skydiver body axes orientation relative to the space-fixed axes, heading (psi), pitch down (theta), and bank. Applying the matrix leads to the resulting terms:

### \overline{\ddot{X}}=\ddot{x}·(cos ψ cos θ)

+ÿ·(−sin 0 cos φ+cos ψ sin 0 sin φ)
+\ddot{z}·(sin ψ sin φ+cos ψ sin θ cos φ)
   Ÿ̅=\ddot{x}·(sin ψ cos θ)
+ÿ·(cos ψ cos φ+sin ψ sin θ sin φ)
+\ddot{z}·(−cos ψ sin φ+sin ψ sin θ cos φ)

### \overline{\ddot{Z}}=\ddot{x}·(−sin θ)

+ÿ·(cos θ sin φ)
+\ddot{z}·(cos θ cos φ)

Each space-axis acceleration is timewise integrated once to determine the space-axis velocities \overline{\dot{X}}, \overline{\dot{Y}}, Ż̅ and a second time to determine the space positions X̅, Y̅, Z̅.

The Euler angle Psi (ψ) is determined from the space velocities as,

$$Psi ( ψ ) = {cos}^{- 1} ( \frac{\dot{{X}_{\_}^{\_}}}{{\dot{{X}_{\_}^{\_}}}^{2} + {\dot{{Y}_{\_}^{\_}}}^{2}} )$$

Next, the derived, calculated or converted data is used to populate data structures for later query and retrieval by the main program 800.

Following completion of the execution of space integration subsystem/module 1800, the skydive phase proceeds to step 848 where wind subsystem/module 1100 (FIG. 11) is executed to determine wind velocities according to an aspect of an embodiment of the present invention

Here, wind look-up tables are provided for wind speed and wind direction vs. altitude from mean sea level (MSL). Wind data are provided from the weather services such as NOAA Winds Aloft, Atmospheric Soundings from University of Wyoming, College of Engineering Department of Atmospheric Science http://weather.uwyo.edu/upperair/sounding.html, or make-believe wind speeds and directions at all altitudes to provide special cases for students. The windline heading constant is the initial trajectory heading velocity in terms of degrees from North, i.e., East is 90°.

Wind speeds in knots are changed to feet per second. Wind directions in degrees are changed to radians. Wind speeds in the space-fixed coordinate system are solved as:

V_{wX̅}=V_{w}·(cos ΔAz cos Az−sin ΔAz sin Az)

V_{wY̅}=V_{w}·(−sin ΔAz cos Az−cos ΔAz sin Az)

The calculated values are then populated within memory data structures for later use.

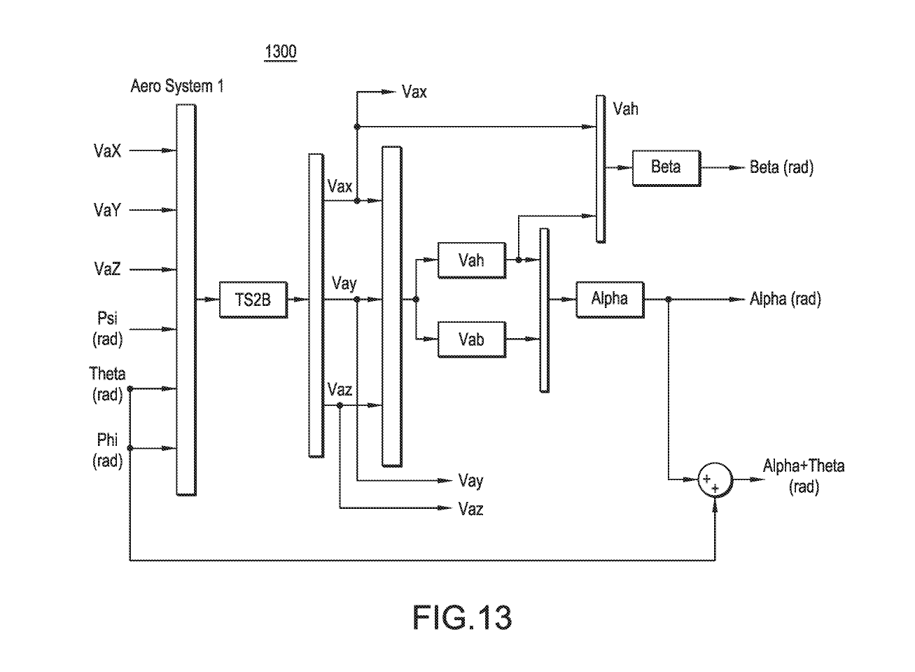

Next, the skydive phase proceeds to steps 850 and 852 where the first Aero Subsystem/Module 1300 (FIG. 13) computes the air flow velocities from the space axis coordinates to the body axis coordinates, the angle-of-attack in the xz-plane, α, and the side-slip angle in the xy plane, β according to aspects of embodiments of the present invention.

Inputs to first Aero Subsystem/Module 1300 are the three-space fixed coordinate system air flow velocities V_{aX̅},V_{aY̅},V_{aZ̅}, and the three Euler angles ψ, θ, φ. The coordinate transformation matrix, T_{s2b} (FIG. 23), is used to derive the air flow velocities along the body axes as Vₐₓ,V_{ay},V_{az}. Then the calculation for the aero angle-of-attack, α, and aero side-slip angle β are performed as follows:

$${V}_{ah} = \sqrt{{V}_{ax}^{2} + {V}_{ay}^{2}}$$

$${V}_{ab} - \sqrt{{V}_{ax}^{2} + {V}_{ay}^{2} + {V}_{as}^{2}}$$

$$α = {cos}^{- 1} ( \frac{{V}_{ah}}{{V}_{ab}} )$$

$$β = {cos}^{- 1} ( \frac{- {V}_{ax}}{{V}_{ah}} )$$

The derived or calculated values are then populated within memory data structures for later use.

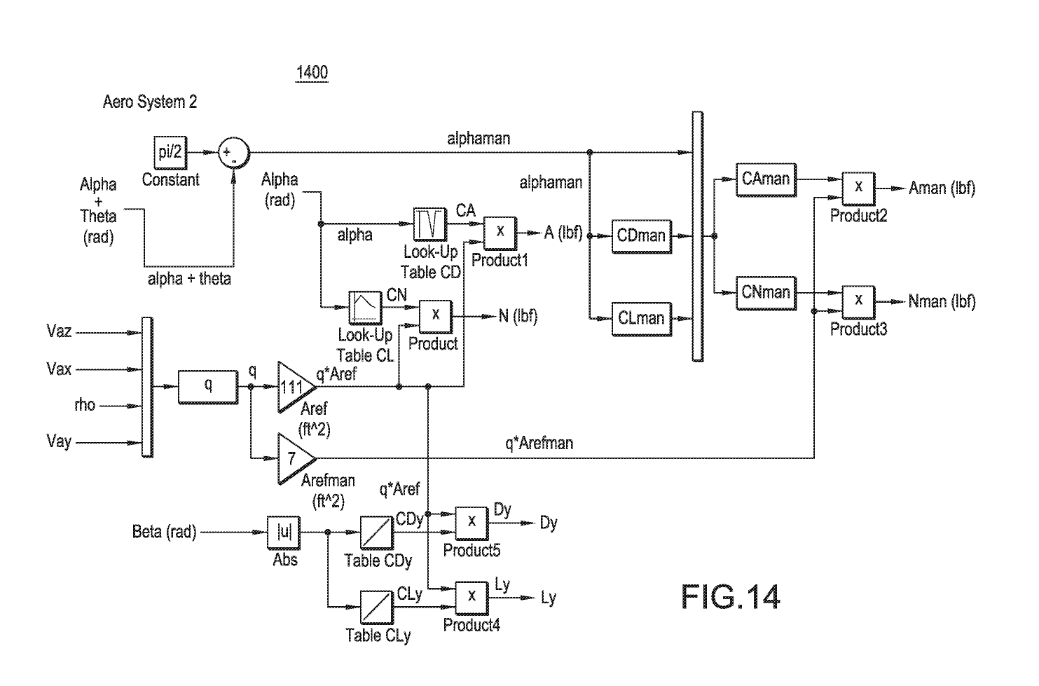

Next, the skydive phase proceeds to steps 854 and 856 for execution of second Aero Subsystem/Module 1400 (FIG. 14) which computes the skydiver man and parafoil axial, normal, drag, and lift forces of the parachute flight simulation program according to aspects of embodiments of the present invention.

Inputs to the second Aero Subsystem/Module 1400 include the airflow velocities Vₐₓ,V_{ay},V_{az},α,β,α+θ, and the atmospheric density rho,

$$ρ ( \frac{lbf}{{ft}^{3}} ) .$$

Aerodynamic reference areas (ft²) are also input for the parafoil, A_{ref}, and the skydiver body, A_{refmax}. A Look up tables are used for the parafoil as C_{A} vs. α, C_{N} vs. α, C_{D}_{_{y}} vs. β, C_{L}_{_{y}} vs. α.

An equation is used for the aero drag and lift coefficients (C_{D}_{ₘᵢₙ}, C_{L}_{ₘₐₓ}) vs (α±θ) as follows:

C_{D}_{ₘₐₓ}=1.1·sin αₘₐₓ³+0.1

C_{L}_{ₘₐₓ}=1.1·sin αₘₐₓ²+cos αₘₐₓ

where,

$${α}_{man} = \frac{π}{2} ( radians ) - ( α + θ ) ( radians )$$

These drag and lift coefficients are converted to axial and normal force coefficients by the equations:

C_{A}_{ₘₐₓ}=C_{D}_{ₘₐₓ}·cos αₘₐₓ−C_{L}_{ₘₐₓ}·sin αₘₐₓ

C_{N}_{ₘₐₓ}−C_{L}_{ₘₐₓ}·cos αₘₐₓ+C_{D}_{ₘₐₓ}·sin αₘₐₓ

Note:

A axial normal force is in the −x direction
N normal force is in the +z direction
Aₘₐₓ is in the +2 direction
Nₘₐₓ is in the +x direction

The aero dynamic pressure, q, is solved by:

q=½ρVₐ² where Vₐ+\sqrt{Vₐₓ²+V_{ay}²+V_{az}²}

The aero forces are solved as:

F_{oafn}=(C_{A} or C_{X})·q·A_{ref}

The solved or determined forces are then populated into data structures.

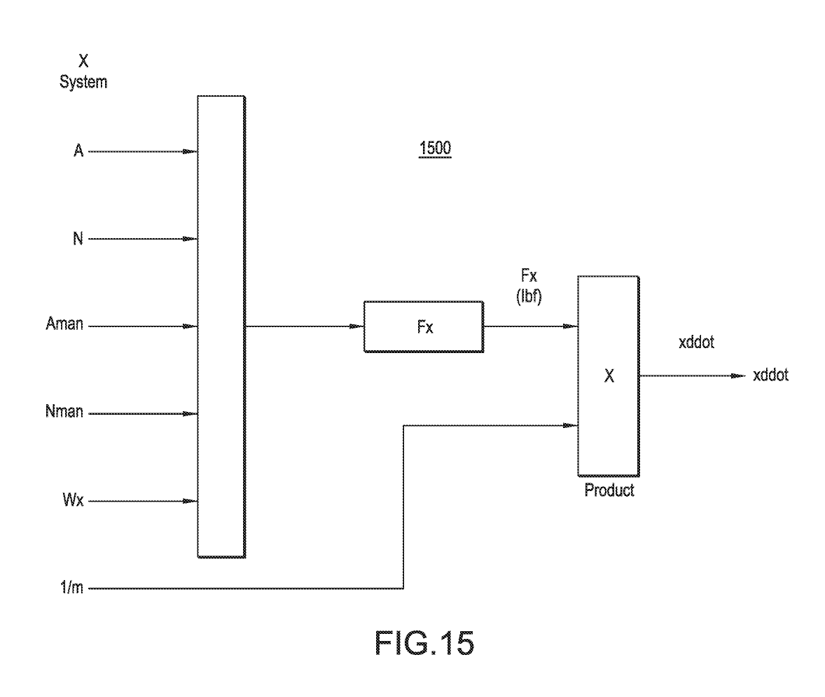

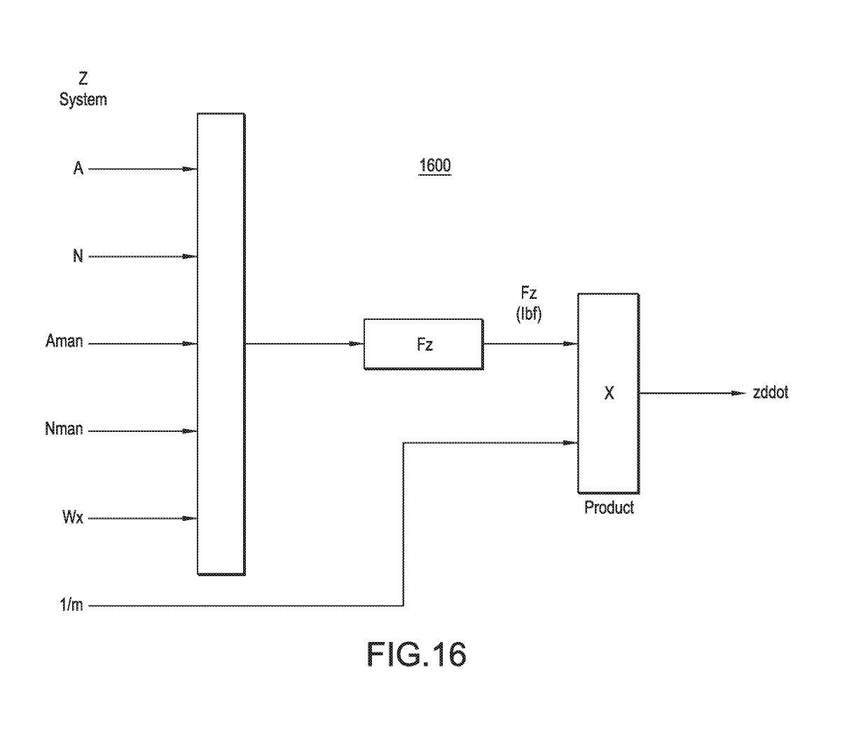

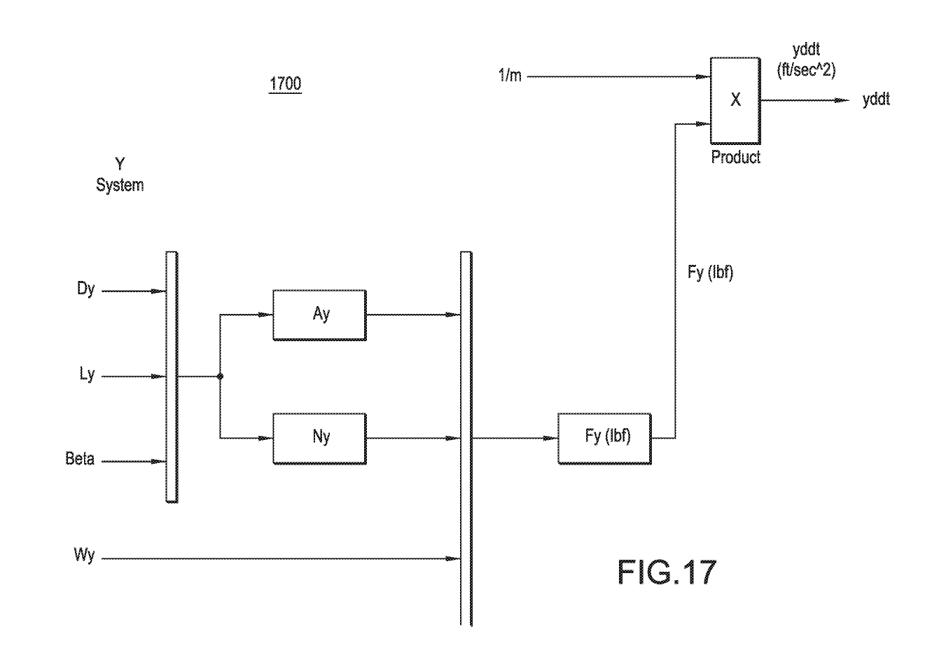

Next, the skydive phase proceeds to step 858 for execution of x-Subsystem/Module 1500 (FIG. 15) which accounts for the aerodynamic and gravity forces to compute the acceleration on the skydiver system in the body axis x-direction, z-Subsystem/Module 1600 (FIG. 16) which accounts for the aerodynamic and gravity forces to compute the acceleration on the skydiver system in the body z-axis direction and y-Subsystem/Module 1700 (FIG. 17) which accounts for the aerodynamic and gravity forces to compute the acceleration on the skydiver system in the body y-axis direction all according to aspects of embodiments of the present invention.

Inputs to x-subsystem/module 1500 include A(lbf), Nₘₐₓ(lbf), Wₓ(lbf), and

$$\frac{1}{m} \frac{ft}{( lbf \cdot {sec}^{2} )} .$$

The total force in the x-direction is given by

Fₓ(lbf)=Wₓ−A+Nₘₐₓ

multiplying

$${F}_{x} ( lbf ) \cdot \frac{1}{m} ( \frac{ft}{lbf \cdot {sec}^{2}} ) = \ddot{x} ( \frac{ft}{{sec}^{2}} )$$

Acceleration along the x-body axis
Inputs to x-subsystem/module 1600 include N(lbf), Aₘₐₓ(lbf), W_{z}(lbf), and

$$\frac{1}{m} \frac{ft}{( lbf \cdot {sec}^{2} )} .$$

The total force in the z-direction is given by

F_{z}(lbf)=W_{z}+N+Aₘₐₓ

multiplying

$${F}_{z} ( lbf ) \cdot \frac{1}{m} \frac{ft}{( lbf \cdot {sec}^{2} )} . = \ddot{z} ( \frac{ft}{{sec}^{2}} )$$

Acceleration along the z-body axis
Inputs to y-Subsystem/module 1700 include D_{y}(lbf), L_{y}(lbf), β(rad), W_{y}(lbf), and

$$\frac{1}{m} \frac{ft}{( lbf \cdot {sec}^{2} )} .$$

The total force in the y-direction is given by

F_{y}(lbf)=W_{y}+A_{y}+N_{y}

where

A_{y}=D_{y}·cos β−L_{y}·sin β

N_{y}=D_{y}·sin β−L_{y}·cos β

multiplying

$${F}_{y} ( lbf ) \cdot \frac{1}{m} ( \frac{ft}{lbf \cdot {sec}^{2}} ) = \ddot{y} ( \frac{ft}{{sec}^{2}} )$$

Acceleration along the y-body axis. The solved or determined results are then populated into data structures.

Next the skydive phase proceeds to step 860 through 864 for execution of the Space Integration Subsystem/Module 1800 (FIG. 18) which solves the overall accelerations, velocities, and positions along the fixed space axes coordinates according to an aspect of an embodiment of the present invention.

Data look-up tables are provided for windspeed and direction vs. altitude, air density (ρ) vs. altitude, parafoil drag and lift coefficients vs. angle-of-attack (α). Equations are used for the skydiver body drag and lift vs. angle-of-attack (αₘₐₓ). Space Integration Subsystem 1800 inputs include the three Euler angles Psi (ψ), Theta (θ), and Phi (ψ) along with the three body-axis accelerations \ddot{x}, ÿ, \ddot{z}. Outputs include the three space velocities (V_{X},V_{Y},V_{Z}), the three space positions (X̅,Y̅,Z̅), and the heading angle Psi (ψ). The outputs are then populated within data structures.

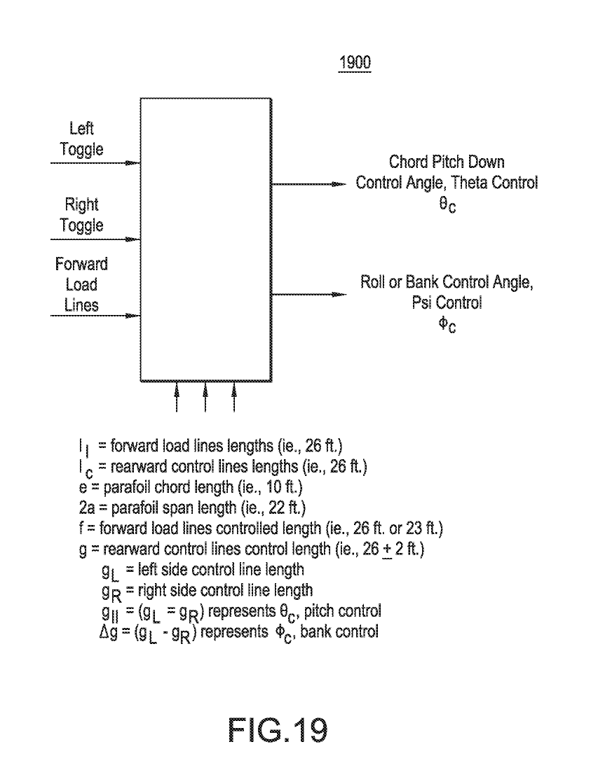

Next, skydive phase, also in step 864 executes Control Line and Bank Angle Subsystem/Module 1900 (FIG. 19) which solves the chord pitch-down angle, and roll (or bank) angle from the skydiver parafoil toggle and front-riser positions according to an aspect of an embodiment of the present invention.

Two hand-held toggles are connected to rearward control lines, which are connected to rear sections of the parafoil canopy on the right and left-sides respectively. Parallel (equal) deflections of the left and right toggles result in parafoil pitch angle, θ_{c}, change. Differential deflections create a bank angle, φ_{c}, change. Often the left and right toggle deflections will have both parallel and differential components. In these cases, both a change in parafoil pitch angle, θ_{c}, and bank angle, φ_{c}, will occur.

Let g represent the control line length, so that g_{L} and g_{R} represent the left and right lengths. Then given a set of left and right control line lengths (i.e., toggle positions), the pitch control is derived from the portion of the similar deflection amount on each side and the bank control is derived from the amount of the difference.

Arithmetically,

g_{∥}=g_{L}=g_{R}, represents θ_{c}, pitch control.

Δg=g_{L}−g_{R}, represents φ_{c}, bank control.

Detailed geometric trigonometric derivations have been performed to determine the effect of g_{∥} and Δg on the control angles and as follows:

### Pitch Angle Control, θ_{c}

Assuming the same amount of control line lengths on both left and right sides, g_{∥} (g parallel). That is, the amount of control lines deflection which is the same on both left and right sides of the parafoil creates a pitch control angle, θ_{c}.

The controlled pitch down angle of the parafoil chord line is given by

θ_{c}=90°−ε−δ

where

$$ε = {sin}^{- 1} ( \frac{f}{s} \cdot {sin}^{- 1} L )$$

$$L = {cos}^{- 1} ( \frac{{e}^{2} - {f}^{2} - {g}_{∥}^{2}}{- 2 {fg}_{∥}} )$$

$$δ = {sin}^{- 1} ( \frac{e}{2 {g}_{∥}} \cdot \frac{{F}_{a}}{{F}_{g}} )$$

where

Fₐ=N(lbf)

F_{g}=W(lbf)

Note: Manufacturer's rigger may lengthen the rearward control lines to provide a downward (positive) tilt angle, θ₀, at a toggles reference position; so that the vertical pitch angle will become:

θ=θ₀+θ_{c}

### Forward Load Lines Control

For a deep dive the toggles may be released and the forward load lines shortened by a downward pull by both hands of the skydiver; thereby effectively changing the forward line lengths from f=lₗ to f=lₗ−Δl. The above equations are also used for this forward load line control.

### Bank Angle Control, φ_{c}

The difference in the left and right control line lengths, Δg=(g_{L}−g_{R}) causes a tilt of the parafoil and a bank angle. The bank angle causes the aero normal force vector, N, to tilt in the direction of the bank and accelerate in that direction.

The bank angle control of the parafoil is given by

φ_{c}=90°−γ−δ_{φ}

where

$$γ = {sin}^{- 1} ( \frac{{g}_{R}}{2 a} \cdot sin μ )$$

$$μ = {cos}^{- 1} ( \frac{{g}_{L}^{2} - {g}_{R}^{2} - {( 2 a )}^{2}}{2 {g}_{L} {g}_{R}} )$$

$${δ}_{φ} = {sin}^{- 1} ( \frac{a}{{g}_{L}} \cdot \frac{{F}_{a}}{{F}_{g}} )$$

where

a=semi−span length (fl)

Fₐ=N(lbf)

F_{g}=W(lbf)

Because of the parafoil roll or bank angle, φ, the skydive heading, ψ, velocity vector will turn. Note: A right toggle down causes a positive right bank angle φ=+ and a turn to the right, which in turn causes a negative change in the heading angle, ψ.

### Skydive Heading Angle, ψ, Psi.

The heading angle, ψ, is the azimuth angle of the skydive velocity vector in the horizontal plane X̅Y of space coordinates X̅,Y̅,Z̅. The heading angle, ψ, is solved in the space coordinates as follows:

Timewise integrate the heading angle in the space-axes coordinate system:

$$\partial ψ = Δψ ≡ {cos}^{- 1} ( \frac{{V}_{1}^{2} + {V}_{2}^{2} - {w}^{2}}{2 {V}_{1} {V}_{2}} ) , Δt = {t}_{2} - {t}_{1}$$

w²=Δ\overline{\dot{X}}²|Δ\overline{\dot{Y}}²

V₁²=\overline{\ddot{X}}₁²+\overline{\dot{Y}}₁²

V₂²−\overline{\ddot{X}}₂²+\overline{\dot{Y}}₂²

Δ\overline{\dot{X}}=\overline{\dot{X}}₂−\overline{\dot{X}}₁

Δ\overline{\dot{Y}}=\overline{\dot{Y}}₂−\overline{\dot{Y}}₁

Note: The heading angle is the horizontal component of the velocity vector referenced to the initial heading, ψ_{C}.

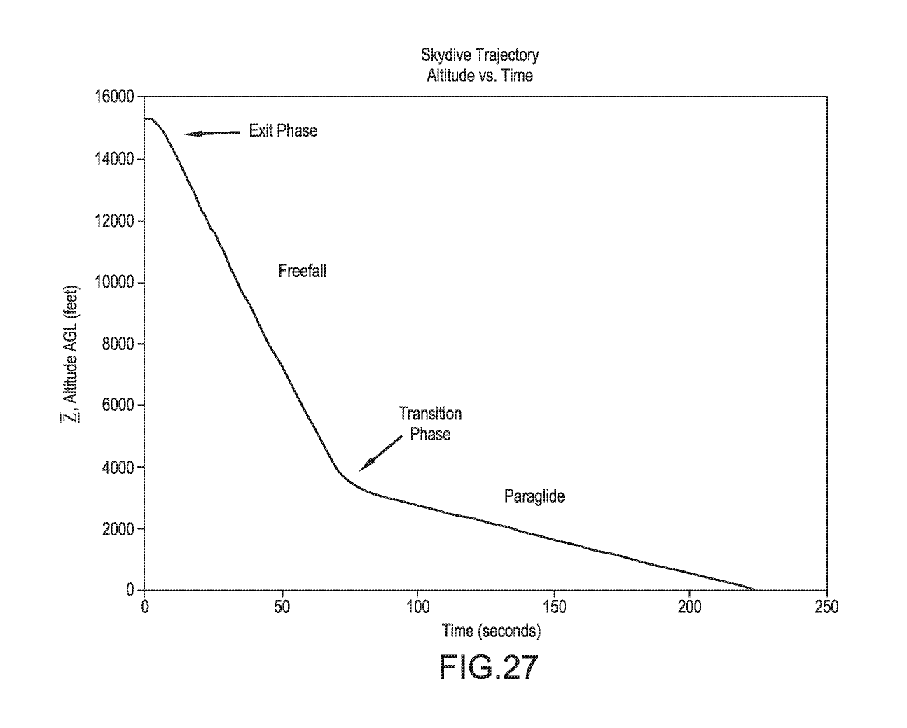

The heading angle Psi, ψ, is referenced to the initial heading angle ψ₀=0 degrees at the start of the simulation run. The resolution of the space axes (X̅,Y̅,Z̅) angle to the geographic coordinates (North, East, South, West) is shown in FIG. 27.
The results are summarized as,

ψ̅_{geo}=ψ̅_{0 geo}−ψ

where

$$ψ = {tan}^{- 1} \frac{{V}_{{Y}_{\_}^{\_}}}{{V}_{{X}_{\_}^{\_}}} , same as {tan}^{- 1} \frac{\dot{{Y}_{\_}^{\_}}}{\dot{\underline{X}}}$$

ψ̅_{geo} is geographical heading
ψ̅_{0 geo} is initial simulation heading
ψ space axes heading, ψ=0 at ψ̅_{0 geo}

### Parafoil Pressure Deflation and Stall Warning

The skydiver and parafoil face along the velocity vector. That is, the body x-axis is along the space-axis velocity vector, \vec{V}_{X̅Y̅Z̅}. The parafoil inflated shape depends upon the ram-air inflation pressure at the forward inlet. The ram-air pressure must be greater than a safety factor above any local aerodynamic pressure about the exterior surfaces of the parafoil. Otherwise parafoil deflation will occur, and a stall will result.

The ram-air pressure is given by the sum of the static atmospheric pressure, p_{∞}, and the dynamic pressure q=½ ρ_{∞}vₐ² where
ρ_{∝}=atmospheric density
vₐ=forward skydiver air-flow velocity

Detailed calculations indicate that at least a

$${v}_{a} = 5 \frac{ft}{sec}$$

forward velocity is required to provide an adequate safety margin for most skydiving conditions. During a 180° turn in a strong headwind, the wind speed increases the ram-air pressure at the start, but reduces it when heading downwind.

The skydive simulation program includes a pressure deflation and stall warning based upon the above concept.

### Conversion of Trajectory Space Coordinates to Geographic Coordinates

The trajectory space coordinates X̅,Y̅,Z̅ are converted to geographic coordinates by the following:

Altitude Above Mean Sea Level=Z̅+Land Surface Altitude (feet)
All Latitude Values are in terms of North Latitude degrees
All Longitude values are in terms of East Longitude degrees

$$ΔLatitude ( deg ) = \frac{ΔLatitude ( ft )}{364 , 816 ( \frac{ft}{deg} )}$$

$$ΔLongitude ( deg ) = \frac{ΔLongitude ( ft )}{364 , 816 ( \frac{ft}{deg} ) \cdot cos ( Latitude ( deg ) )}$$

Latitude (deg)=Latitude at start+ΔLatitude (deg)

Longitude (deg)=Longitude at start+ΔLongitude (deg)

ΔLatitude (ft)=(X̅−Y̅ tan ψ₀)·cos ψ₀

$$ΔLongitude ( ft ) = \frac{{Y}_{\_}^{\_}}{cos {ψ}_{0}} + ( {X}_{\_}^{\_} - {Y}_{\_}^{\_} tan {ψ}_{0} ) \cdot sin {ψ}_{0}$$

where ψ₀ is the initial heading angle.

Note: The initial heading angle, ψ₀, establishes the direction for the space-fixed coordinates X̅,Y̅,Z̅ for the entire trajectory.

Next, skydive phase proceeds to step 866 for integration with Δt (time interval) set at 0.10 s. Additional aspects of embodiments of the present invention contemplate using smaller Δt values for increased accuracy. After this step, the skydive phase ends at step 868 and the process proceeds to the next phase.

Referring now to FIG. 8G freefall phase of the aeromechanical thread of the parachute flight simulation program 800 is shown according to an aspect of an embodiment of the present invention. The freefall phase begins at step 870 at the end of the exit phase and proceeds to decisional step 872 where a determination is made as to whether the altitude is greater than 0. A negative determination leads to the end of the freefall phase (step 878) while an affirmation determination leads to step 874 where a determination is made as to whether the mode deployment altitude and the altitude are greater or equal to the deployment altitude. A negative determination here leads the proceeds to step 878 (end of the phase; beginning of next phase) while an affirmative determination leads to the skydive phase and the process goes through steps 840-868 of the skydive phase, as discussed above.

Referring now to FIG. 8H a transition phase of the aeromechanical thread of the parachute flight simulation program 800 is shown according to an aspect of an embodiment of the present invention. The transition phase begins at step 878 at the end of the freefall phase and proceeds to decisional step 880 where a determination is made as to whether the altitude is greater than 0. A negative determination leads to the end of the phase (step 884) while an affirmative determination leads to decisional step 882 where a determination is made as to whether the altitude is greater or equal to the deployment altitude. A negative determination leads to step 884 (end of phase; beginning of next phase) while an affirmative determination leads to the skydive phase for a repeat of steps 840-868 of the skydive phase, as discussed above.

Referring now to FIG. 8I a paraglide phase of the aeromechanical thread of the parachute flight simulation program 800 is shown according to an aspect of an embodiment of the present invention. The paraglide phase begins at step 884 following the end of the transition phase. The paraglide phase then proceeds to decisional step 886 where a determination as to whether the altitude is greater than 0. A negative determination leads to step 888 (end of the paraglide phase) while an affirmative determination leads to the skydive phase for a repeat of steps 840-868 of the skydive phase, as discussed above.

Returning to FIG. 8A the process flow, after execution of the aeromechanical thread (from step 888; end of paraglide phase) proceeds to step 888A where input controller 104 (or 204, 304) is queried. This is made possible using by checking a loop for input events such as a button press on input controller 104. Toggle inputs on controller 104 are queried for Thumbstick inputs left 104A and right 104B. Button presses can be any button of 104C through 104J. Pulling left thumbstick down 104A is equivalent to pulling the left toggle down. Pulling right thumbstick 104B down is equivalent to pulling the right toggle down. Pushing and holding any of the buttons and pulling a toggle down is equivalent to a front riser pull in that direction. Alternatively pressing the thumbstick up, either left or right, or both at same time, without button press will also pull down on the front riser, left or right, or both at the same time.

For example, if a button (any one of 104C through 104J) is pressed and left thumbstick 104A is pulled down, this will be equivalent to a left front riser pull down. And the same for any button (any one of 104C through 104J), and right thumbstick 104B, is equivalent to a right front riser pull down. The toggles are used for gliding and braking controls, while the front risers are for diving. When the thumbstick on the controller 104 is in the neutral unpressed position, it returns 0 for the Y axis value. Pressing the thumbstick down will return a real number less than 0 with a maximum of −1. When the thumbstick is pressed down entirely a value of −1 will be returned. This is translated to a percentage by multiplying×100. If left toggle 104A is pulled 50% down, then the value returned is −0.5, which will be converted, in step 888B by a conversion module into a dataset readable by the aeromechanical module and applied to the phase of the skydiver by passing these converted input datasets/events to the aeromechanical thread in step 890A. Next, in step 890B, the aero thread is queried (by execution of a query module) for current position and orientation, or attitude, information of the current skydiver. Additionally, in step 892A, the multiplayer thread is queried (by execution of the query module) for other skydivers' positions and orientations, or attitudes. In an aspect of an embodiment of the present invention, the multiplayer thread may be queried by a different (i.e. second) query module. Once this data is received, data structures within server 108 may be updated with this information. Next, the orientation, or attitude, of the Head Mounted Display 104 is queried in step 894B by the query module. In an aspect of an embodiment of the present invention, the Head Mounted Display 104 may be queried by a separate HMD query module. Next, in step 896A, the camera view positioned on the skydiver's 3D body is rendered on a Computer Display 106 and Head Mounted Display 104 in step 896B. Next, the thread of execution will sleep in step 989A for a small delay yielding to the Central Processing Unit (CPU) to the Operating System to perform other tasks and then proceeds to decisional step 898B to determine whether a command had been received to end the program. If a negatives determination is made, the process reverts to step 888A. If an affirmative determination is made, the process ends.

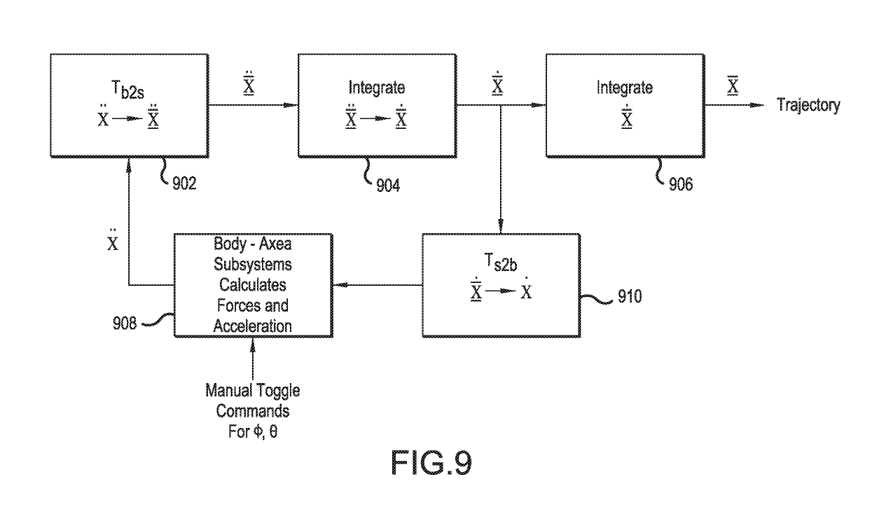

Referring now to FIG. 9 a process flow of the skydive simulation aeromechanics module 900 is shown according to an aspect of an embodiment of the present invention. As shown, the closed-loop section feeds back the space axes velocities \overline{\dot{X}}, \overline{\dot{Y}}, \overline{\dot{X}} through a space-axes to body-axes transformation matrix (T_{a2b}) 910 to obtain the body-axes velocities \dot{x}, \dot{y}, ż (908). These velocities are then used to solve the aerodynamic forces on both the parafoil and the skydiver. These forces are combined with the gravity forces and are divided by the system mass to obtain the accelerations in terms of the body-axes. A body-axes to space-axes transformation matrix (T_{b2s}) (902) is used to determine the space-axes accelerations, which are then timewise integrated (904) once to determine the space-axes velocities \overline{\dot{X}}, \overline{\dot{Y}}, Ż̅ and a second time (906) to determine the space-axes positions X̅,Y̅,Z̅. The body-axes subsystems 908 include the resolved aerodynamic and gravity forces and include the skydiver toggle commands for parachute pitch down θ and bank angles φ. In sum, the combined effect of the components of module 900 are to: Transform body-axes accelerations to space-axes, transform space-axes velocities to body axes, integrate space-axes accelerations to velocities, integrate space-axes velocities to positions and calculate forces and accelerations in terms of the skydiver system body-axes.

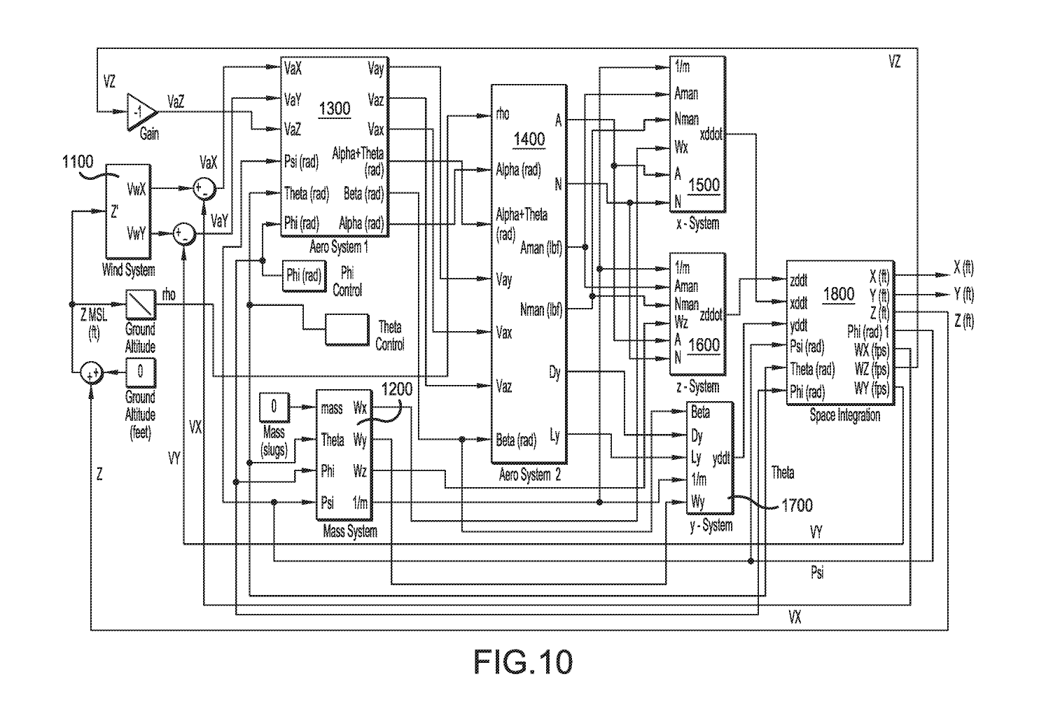

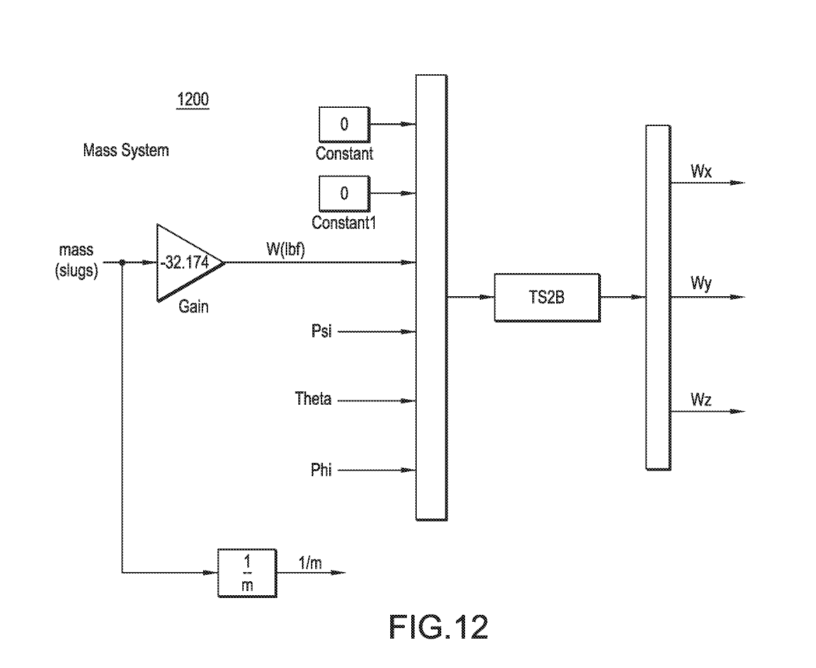

Referring now to FIG. 10 a more detailed block diagram 1000 of the skydive simulation aeromechanics module 900 is shown along with its constituent subsystems/modules according to an aspect of an embodiment of the present invention. Reference is also made to FIGS. 11-18 which detail each subsystem/module.

Aeromechanics module 900 includes wind subsystem/module 1100. Wind module 1100's input includes the altitude above sea level, Ż̅; and the outputs are the wind speeds at the various trajectory altitudes Z̅ in the space-fixed X̅ and Y̅ directions as V_{wX̅} and V_{wY̅}. These outputs are subtracted respectively by the trajectory velocities V_{X̅} and V_{Y̅} to form the air-flow velocities as V_{aX̅}=V_{wX̅}−V_{X̅} and V_{aY̅}=V_{wY̅}−V_{Y̅}.

Provision is also made to include vertical wind velocities as V_{aZ̅}=V_{wZ̅}−V_{Z̅} to accommodate future requirements for vertical wind effects and wind turbulence models.

Aeromechanics module 900 also includes mass subsystem/module 1200 whose inputs include the system mass in slugs and the three Euler Angles Psi (heading ψ), Theta (Parafoil Pitch Down, θ) and Phi (roll or bank, φ). The outputs are the system weight distribution among the three body-axes as Wₓ, W_{y}, W_{z}. The reciprocal mass is also an output to be used in the body-axes acceleration computations.

Aeromechanics module 900 also includes first Aero Subsystem/module 1300 whose inputs include the three air-flow velocities, V_{aX̅},V_{aY̅},V_{aZ̅}, and three Euler angles ψ, θ, φ. The outputs include the aerodynamic angle-of-attack Alpha (α) and side-slip angle Beta (β) in addition to the air-flow velocities along the body-axes as Vₐₓ,V_{ay},V_{az}. Alpha plus Theta (α+θ) is also output for the subsequent calculation of drag force and lift force imparted to the suspended skydiver body. Aeromechanics module 900 also includes first Aero Subsystem/module 1400 whose inputs include Alpha (β), Beta (β), Alpha plus Theta (α+θ), atmospheric density Rho (ρ) and the body-axes air-flow velocities (Vₐₓ,V_{ay},V_{az}). The outputs include the Axial Force (A) and the Normal Force (N) applied relative to the parafoil body-axes x,y,z and the Axial Force (Aₘₐₓ) and Normal Force (Nₘₐₓ) applied relative to the same parafoil body-axes. The side-slip forces are applied to the parafoil axes as drag (D_{y}_{ᵢ}) and lift (L_{y}_{ᵢ}), axial force (A_{y}) and normal force (N_{y}). Aeromechanics module 900 also includes body-axis x Subsystem/module 1500 whose inputs include the parafoil aerodynamics axial force A, normal force N, and the skydiver body aerodynamic forces Aₘₐₓ and Nₘₐₓ. The reciprocal system mass is also an input for convenience in determining the x-direction acceleration, \ddot{x}. Also, the gravity force x component Wₓ is the input.

Aeromechanics module 900 also includes body-axis z Subsystem/module 1600 whose inputs include the parafoil aerodynamics axial force A, normal force N, and the skydiver body aerodynamic forces Aₘₐₓ and Nₘₐₓ. The reciprocal system mass is also an input for convenience in determining the z-direction acceleration, \ddot{z}. Also, the gravity force z component W_{z} is the input.

Aeromechanics module 900 also includes body-axis y Subsystem/module 1700 whose inputs include Beta (β), aero drag (D_{y}), aero lift (L_{y}), system mass (m), reciprocal mass

$$( \frac{1}{m} ) ,$$

and the bank angle Phi (φ). The output is the system acceleration in the y-direction, ÿ.

Aeromechanics module 900 also includes Space Integration Subsystem/module inputs include the three Euler angles Psi (ψ), Theta (θ), and Phi (φ) along with the three body-axis accelerations \ddot{x}, ÿ, \ddot{z}. Outputs include the three space velocities (V_{X̅},V_{Y̅},V_{Z̅}), the three space positions (X,Y,Z), and the heading angle Psi (ψ).

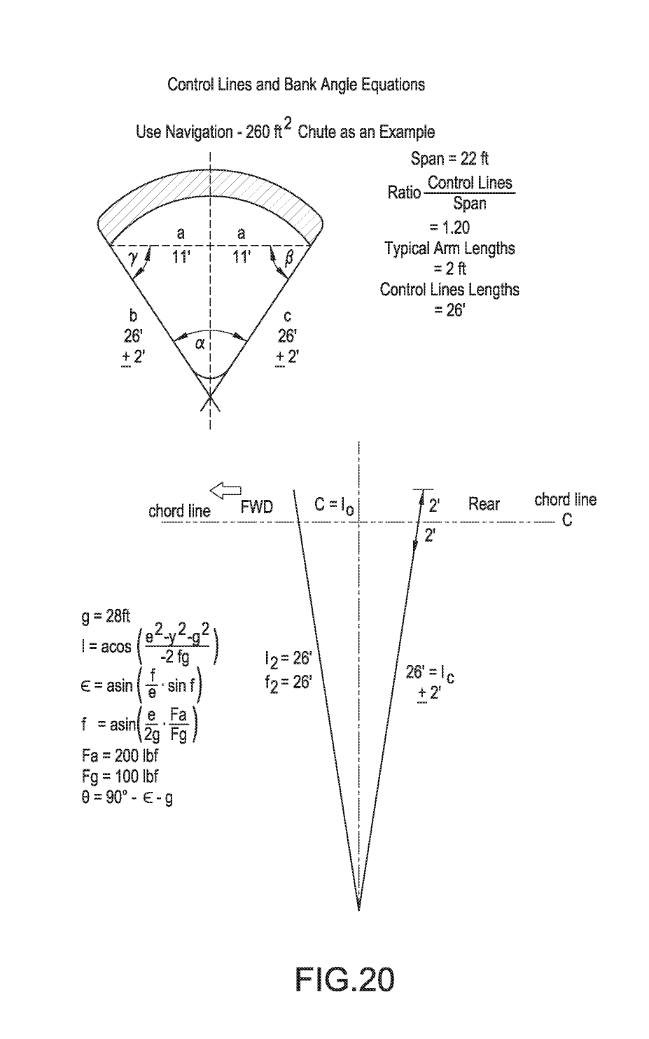

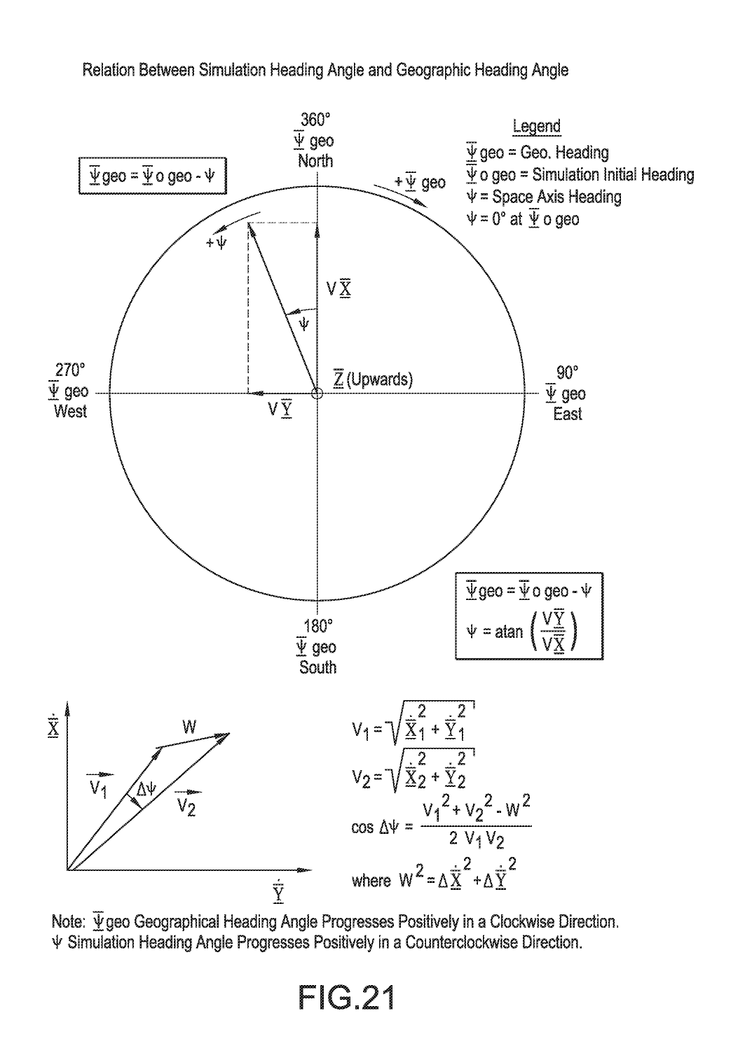

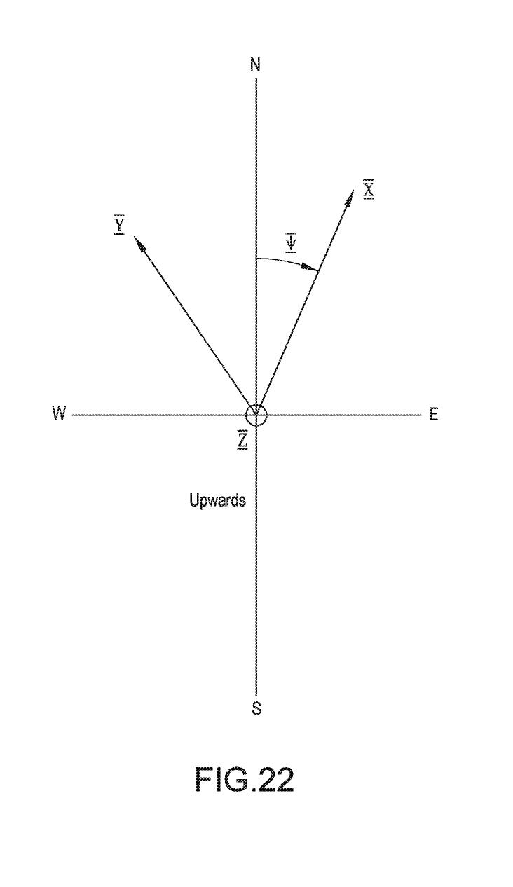

Referring now to FIGS. 19 and 20 Control Line and Bank Angle Subsystem/Module 1900 along with Control Line and Bank Angle equations are shown according to an aspect of an embodiment of the present invention. Control Line and Bank Angle Subsystem/Module 1900 solves the chord pitch-down angle, and roll (or bank) angle from the skydiver parafoil toggle and front-riser positions according to an aspect of an embodiment of the present invention. Here, two hand-held toggles are connected to rearward control lines, which are connected to rear sections of the parafoil canopy on the right and left-sides respectively. Parallel (equal) deflections of the left and right toggles result in parafoil pitch angle, θ_{c}, change. Differential deflections create a bank angle, φ_{c}, change. Often the left and right toggle deflections will have both parallel and differential components. In these cases, both a change in parafoil pitch angle, θ_{c}, and bank angle, φₙ, will occur.

Let g represent the control line length, so that g_{L} and g_{R} represent the left and right lengths. Then given a set of left and right control line lengths (i.e., toggle positions), the pitch control is derived from the portion of the similar deflection amount on each side and the bank control is derived from the amount of the difference. Arithmetically,

g_{∥}=g_{L}=g_{R}, represents θ_{c}, pitch control.

Δg=g_{L}−g_{R}, represents φ_{c}, bank control.

Detailed geometric trigonometric derivations have been performed to determine the effect of g_{∥} and Δg on the control angles and as follows:

### Pitch Angle Control, θ_{c}

Referring to FIG. 20 The same amount of control line lengths on both left and right sides, g_{∥} (g parallel).

That is, the amount of control lines deflection which is the same on both left and right sides of the parafoil creates a pitch control angle, θ_{c}.
The controlled pitch down angle of the parafoil chord line is given by

θ_{c}=90°−ε−δ
where

$$ε = {sin}^{- 1} ( \frac{f}{e} \cdot {sin}^{- 1} L )$$

$$L = {cos}^{- 1} ( \frac{{e}^{2} - {f}^{2} - {g}_{∥}^{2}}{- 2 {fg}_{∥}} )$$

$$δ = {sin}^{- 1} ( \frac{e}{2 {g}_{∥}} \cdot \frac{{F}_{a}}{{F}_{g}} )$$

where

Fₐ=N(lbf)

F_{g}=W(lbf)

Note: Manufacturer's rigger may lengthen the rearward control lines to provide a downward (positive) tilt angle, θ₀, at a toggles reference position; so that the vertical pitch angle will become:

θ=θ₀+θ_{c}

### Typical Skydive Trajectories

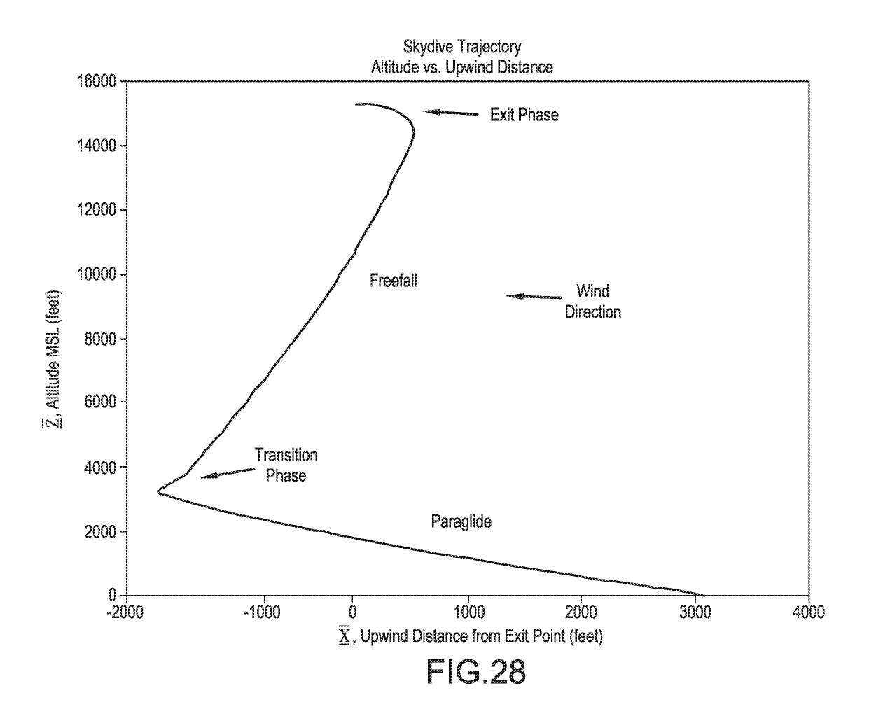

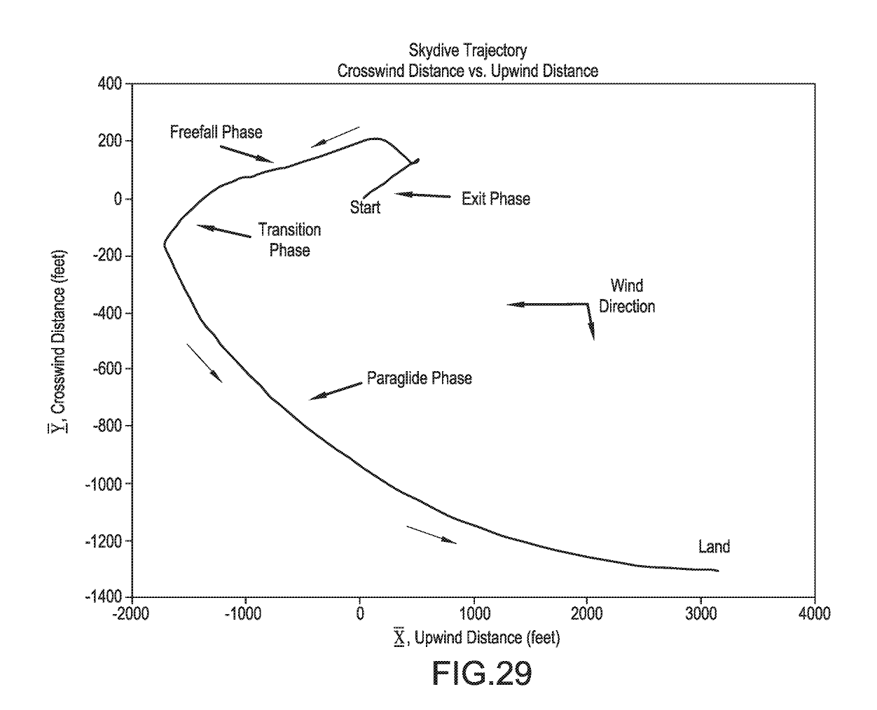

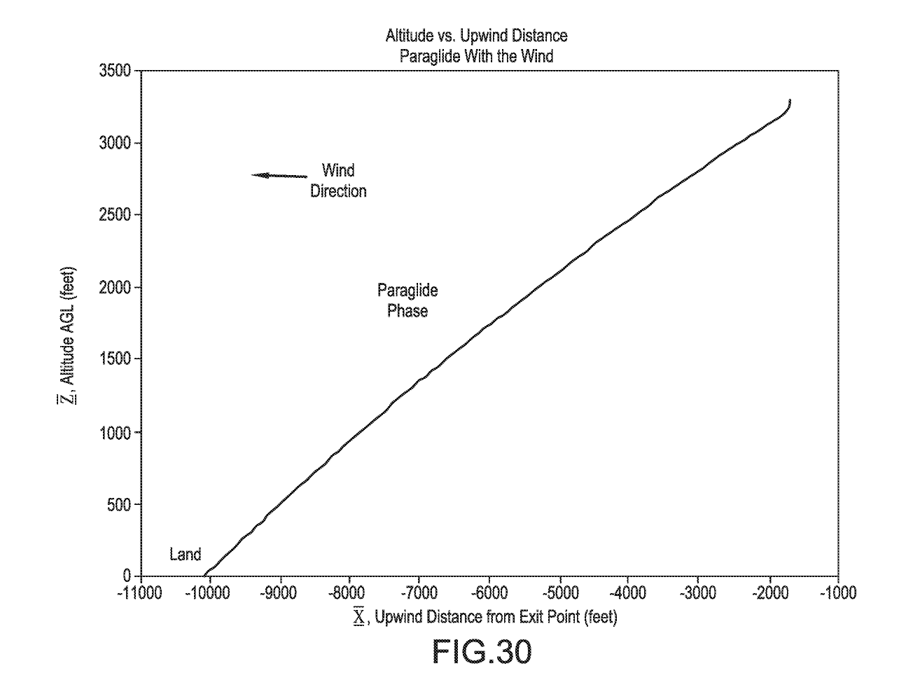

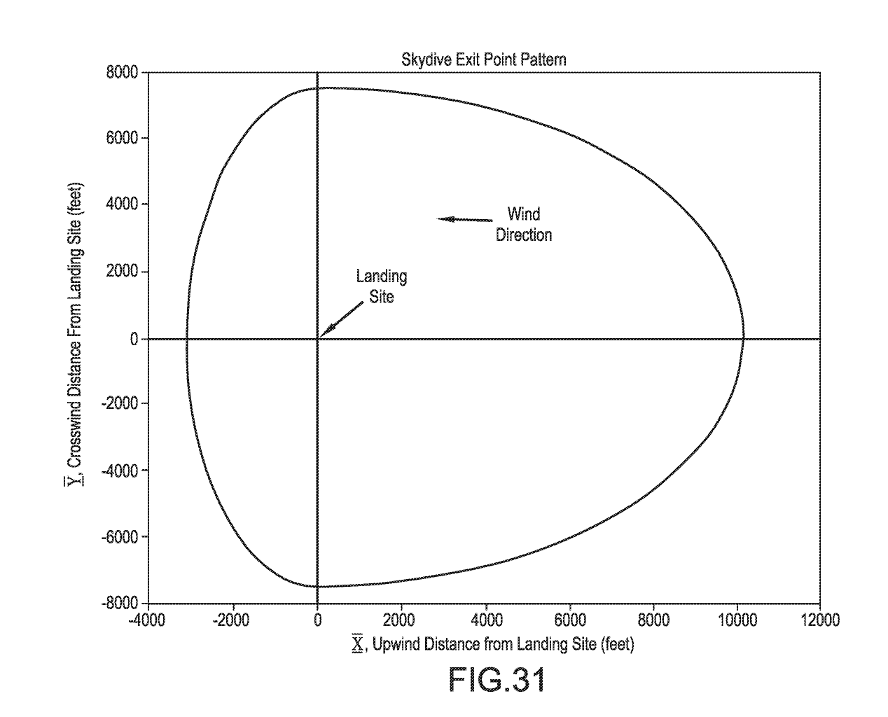

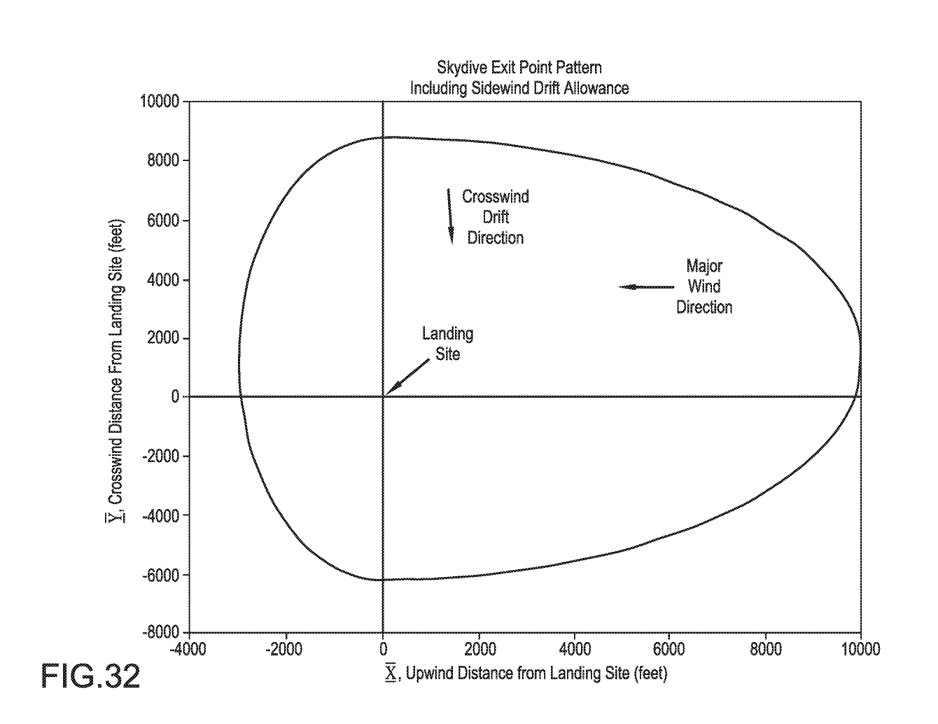

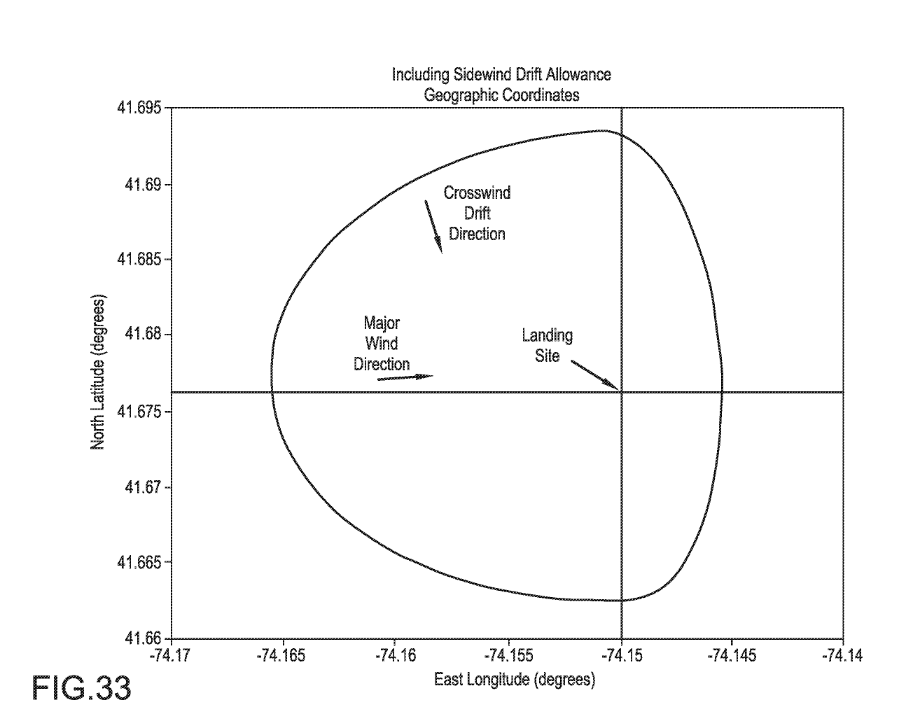

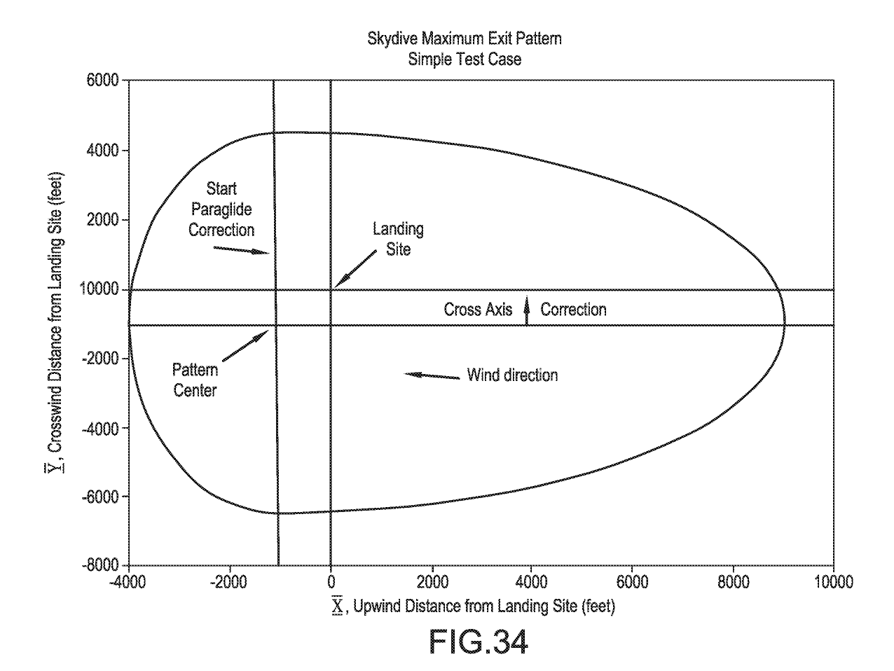

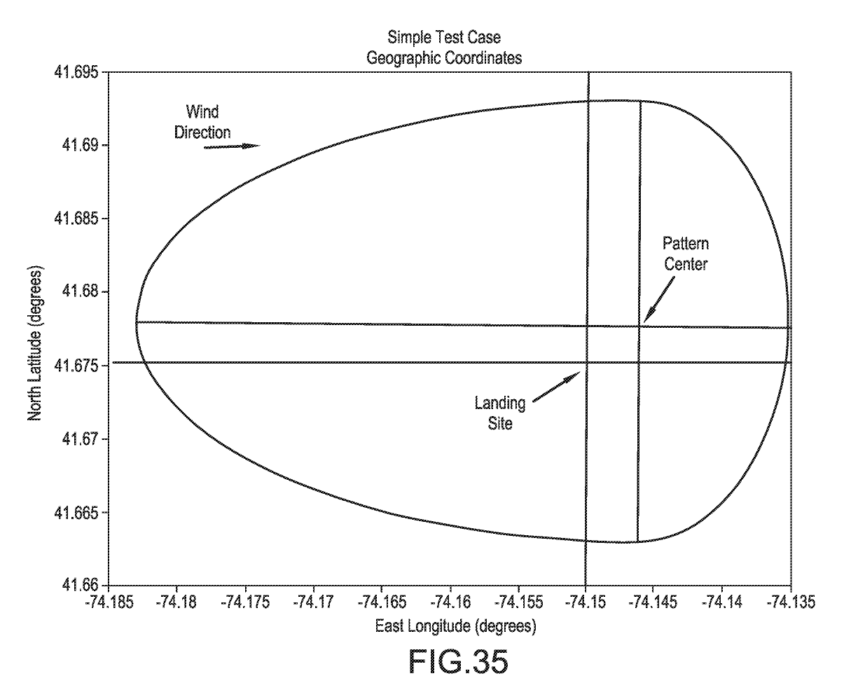

Referring now to FIGS. 27-30 graphs of the simulated typical skydive trajectories are shown. Typical skydive trajectory simulation results are presented from aircraft exit through freefall and paraglide phases. Wind conditions do not significantly affect the altitude vs. time results, but do affect the landing points. FIG. 28 shows a landing point 3,000 feet up range from the aircraft exit point with the paraglide against the wind. FIG. 29 shows the paraglide with the wind at a landing point of 10,000 feet downwind from aircraft exit (i.e., −10,000 ft. upwind distance).

### Typical Spot Application Patterns

The spot patterns are ellipses which represent the maximum horizontal distances between aircraft exit and the desired landing point (drop zone). The spot patterns depend on the momentum vector applied to the exiting skydiver by the aircraft velocity and the wind vs. altitude profile from the ground to aircraft exit altitude.

A single exit point pattern is presented in FIG. 37 without any side wind components and the outputs in terms of the X̅ and Y̅ distances. FIG. 38 includes crosswind effects. FIG. 39 has the effective wind coming from the opposite direction and has outputs in terms of East Longitude (degrees) and North Latitude (degrees).

### Nomenclature

Space Fixed Coordinates:
X̅ is horizontal axis of initial skydiver heading
Y̅ is also horizontal axis 90° to the left of X̅
Z̅ is the upwards vertical direction starting at the local ground level.
Ż̅ is the altitude above mean sea level (MSL)
Ż̅ is used for wind and atmospheric density tables
Ż̅=Z̅+local site altitude above MSL
ψ̅ is the initial heading angle of the trajectory relative to true geographic north
ψ is the heading angle during the trajectory run

Body Axes Coordinates:
x is along the parafoil chord line
y is 90° to the left of x
z is 90° upwards from the xy-plane
θ is the parafoil chord line pitch-down angle from the X̅Y̅-plane (local horizontal)
φ is the chord line roll or bank angle from the X̅Y̅-plane (local horizontal)

Euler Angle Directions (Polarities)
ψ positive+Nose left heading angle about Z̅
θ positive+Nose down pitch angle about y
φ positive+Right wing down roll or bank angle about x

### Glossary

Azimuth—The angle rotating from True North (at 0 degrees) in a clockwise direction around to True North (360 degrees)
Windline—The effective average wind direction for a given jump. It is the azimuth angle line of the effective average headwind. For example, a West wind average has an azimuth of 270 degrees. The Windline is determined with the measured wind speeds and directions at the various altitudes by an algorithm which “weights” the effect of the wind layers on the Skydive trajectory phases. The Windline establishes the trajectory x-axis with the positive direction facing into the headwind.
Heading—The azimuth orientation of the aircraft velocity vector at the time of Exit
Bearing—The azimuth orientation of the Landing site location relative to the Exit point where the Latitudes and Longitudes of both sites are involved in the calculation
X-Axis—The trajectory axis line (coordinate) along the Windline with the positive direction pointing into the headwind
Y-Axis—The trajectory axis line perpendicular to the x-axis with the positive direction pointing to the left when facing along the x-axis
Z-Axis—The vertical trajectory line (altitude AGL), which is perpendicular (orthogonal) to the other two axes.
Skydive Flight Phase—The skydive trajectory is broken up into four flight phases as Exit, Freefall, Transition, and Paraglide. Exit is about 5 second after leaving the aircraft while establishing the freefall altitude. Freefall is descent with a particular body attitude to the initial parachute opening. Transition is during the initial parachute high deployment dynamics when the decelerations are large. Paraglide is the long steady-state gliding period after ram-air inflation of the canopy to a sub-sonic airfoil shape. The end of the paraglide period is at an altitude of 300 feet where the landing pattern starts.
Parafoil Chord Line—The chord line is the line running from the middle of the ram-air inflated parafoil canopy nose to the middle of the trailing edge
Chord Tilt—The chord tilt is the angle between the chord line and the local horizontal. A positive tilt angle is the leading edge (nose) downwards. Increasing the tilt angle increases the descent velocity
Airflow Velocity—The velocity of the airstream flowing onto a body, i.e., skydiver's body or parafoil
Angle-of-Attack—The angle formed by the vertical component of the airflow onto a body
Sideslip Angle—The angle formed by the horizontal component of the airflow onto a body
Flightpath Angle—The angle formed by the body velocity vector with the horizontal
Drag—The aerodynamic force along the direction of the airflow velocity
Lift—The aerodynamic force perpendicular to the direction of the airflow velocity
Dynamic Pressure—The aerodynamic pressure of the air developed by the motion of a body moving through the air

The invention has been described in detail with reference to certain preferred embodiments thereof, but it will be understood that variations and modifications can be effected within the spirit and scope of the invention.

What is claimed is:

1. A computer-implemented method of parachute flight simulation, as executed on a multiplayer game server configured to perform a predefined set of basic operations in response to receiving a corresponding basic instruction selected from a predefined native instruction set of codes, comprising the steps of:
execution of a loading module comprising a set of machine codes selected from the native instruction set for creating data structures for terrains, 3D objects and plane trajectory, wherein terrains are any one or more of: satellite imagery, ground level buildings, trees, terrain, elevation, and other topographic detail, wherein 3D objects are any one or more of: plane of exit, freefalling body of a skydiver, skydiver under open parachute;
execution of multiplayer and aeromechanics modules, wherein execution is any one of: sequential, simultaneous;
execution of a conversion module comprising of a set of machine codes selected from the native instruction set for converting controller inputs into percent left toggle down and percent right toggle down;
execution of a querying module comprising of a set of machine codes selected from the native instruction set for querying the aeromechanics thread for position (x, y, z) and attitude (yaw, pitch, roll);
execution of a querying module comprising of a set of machine codes selected from the native instruction set for querying the multiplayer thread for at least one skydiver position (x, y, z) and attitude (yaw, pitch, roll);
updating at least one skydiver position (x, y, z) and attitude (yaw, pitch, roll); and
rendering at least one image generated from the product of the multiplayer and aeromechanics threads onto at least one display, wherein each of the sets of machine code are stored in a memory.

2. The computer-implemented method of claim 1, wherein execution of the multiplayer module comprises execution of at least one set of machine codes selected from the native instruction set, wherein each of the at least one set of machine codes is separately configured for:
determining connection of the multiplayer module with the multiplayer game server;
sending at least one skydiver's position (x, y, z) and attitude (yaw, pitch, roll) to the multiplayer game server; and
receiving at least one skydiver's position (x, y, z) and attitude (yaw, pitch, roll) from the multiplayer game server.

3. The computer-implemented method of claim 1, further comprising execution of an head mounted display query module wherein the execution comprises execution of at least one set of machine codes selected from the native instruction set, wherein each of the at least one set of machine codes is separately configured for querying a head mounted display for yaw, pitch and roll data.

4. The computer-implemented method of claim 1, wherein execution of the aeromechanics module comprises execution of at least one set of machine codes selected from the native instruction set, wherein each of the at least one set of machine codes is separately configured for:
initializing initial inputs, data points;
populating data structures with aeromechanical coefficients and air density;
execution of an exit phase module comprising of a set of machine codes selected from the native instruction set for determining whether a valid exit condition for an exit phase has been attained, wherein execution of the transition phase module comprises of execution of a skydive phase module;
execution of a freefall phase module comprising of a set of machine codes selected from the native instruction set for determining whether a valid exit condition for a freefall phase has been attained, wherein execution of the transition phase module comprises of execution of a skydive phase module;
execution of a transition phase module comprising of a set of machine codes selected from the native instruction set for determining whether a valid exit condition for an exit phase has been attained, wherein execution of the transition phase module comprises of execution of a skydive phase module; and
execution of a paraglide phase module comprising of a set of machine codes selected from the native instruction set for determining whether a valid exit condition for a paraglide phase has been attained, wherein execution of the transition phase module comprises of execution of a skydive phase module.

5. The computer-implemented method of claim 4, wherein execution of the skydive phase module comprises execution of at least one set of machine codes selected from the native instruction set, wherein each of the at least one set of machine codes is separately configured for:
execution of a space integration subsystem module;
execution of a wind module;
execution of a first aeromechanics subsystem module;
execution of a second aeromechanics subsystem module;
execution of any one or more of: x-subsystem module, y-subsystem module, z-subsystem module; and
execution of a space integration module.

6. A computer program product comprising a non-transitory computer readable medium having control logic stored therein for causing a processor configured to perform a predefined set of basic operations in response to receiving a corresponding basic instruction selected from a predefined native instruction set of codes to enable parachute flight simulation, the control logic comprising computer readable code for:
execution of a loading module comprising a set of machine codes selected from the native instruction set for creating data structures for terrains, 3D objects and plane trajectory, wherein terrains are any one or more of: satellite imagery, ground level buildings, trees, terrain, elevation, and other topographic detail, wherein 3D objects are any one or more of: plane of exit, freefalling body of a skydiver, skydiver under open parachute;
execution of multiplayer and aeromechanics modules, wherein execution is any one of: sequential, simultaneous;
execution of a conversion module comprising of a set of machine codes selected from the native instruction set for converting controller inputs into percent left toggle down and percent right toggle down;
execution of a querying module comprising of a set of machine codes selected from the native instruction set for querying the aeromechanics thread for position (x, y, z) and attitude (yaw, pitch, roll);
execution of a querying module comprising of a set of machine codes selected from the native instruction set for querying the multiplayer thread for at least one skydiver position (x, y, z) and attitude (yaw, pitch, roll);
updating at least one skydiver position (x, y, z) and attitude (yaw, pitch, roll); and
rendering at least one image generated from the product of the multiplayer and aeromechanics threads onto at least one display, wherein each of the sets of machine code are stored in a memory.

7. The computer program product of claim 6, wherein the control logic for execution of the multiplayer module comprises control logic for execution of at least one set of machine codes selected from the native instruction set, wherein each of the at least one set of machine codes is separately configured for:
determining connection of the multiplayer module with the multiplayer game server;
sending at least one skydiver's position (x, y, z) and attitude (yaw, pitch, roll) to the multiplayer game server; and
receiving at least one skydiver's position (x, y, z) and attitude (yaw, pitch, roll) from the multiplayer game server.

8. The computer program product of claim 6, further comprising control logic for execution of a head mounted display query module wherein the control logic comprises control logic for execution of at least one set of machine codes selected from the native instruction set, wherein each of the at least one set of machine codes is separately configured for querying a head mounted display for yaw, pitch and roll data.

9. The computer program product of claim 6, wherein the control logic for execution of the aeromechanics module comprises control logic for execution of at least one set of machine codes selected from the native instruction set, wherein each of the at least one set of machine codes is separately configured for:
initializing initial inputs, data points;
populating data structures with aeromechanical coefficients and air density;
execution of an exit phase module comprising of a set of machine codes selected from the native instruction set for determining whether a valid exit condition for an exit phase has been attained, wherein execution of the transition phase module comprises of execution of a skydive phase module;
execution of a freefall phase module comprising of a set of machine codes selected from the native instruction set for determining whether a valid exit condition for a freefall phase has been attained, wherein execution of the transition phase module comprises of execution of a skydive phase module;
execution of a transition phase module comprising of a set of machine codes selected from the native instruction set for determining whether a valid exit condition for an exit phase has been attained, wherein execution of the transition phase module comprises of execution of a skydive phase module; and
execution of a paraglide phase module comprising of a set of machine codes selected from the native instruction set for determining whether a valid exit condition for a paraglide phase has been attained, wherein execution of the transition phase module comprises of execution of a skydive phase module.

10. The computer program product of claim 9, wherein the control logic for execution of the skydive phase module comprises control logic for execution of at least one set of machine codes selected from the native instruction set, wherein each of the at least one set of machine codes is separately configured for:
execution of a space integration subsystem module;
execution of a wind module;
execution of a first aeromechanics subsystem module;
execution of a second aeromechanics subsystem module;
execution of any one or more of: x-subsystem module, y-subsystem module, z-subsystem module; and
execution of a space integration module.

11. A system for parachute flight simulation comprising:
a controller;
a main server, in communication with the controller, the main server comprising:
a processor configured to perform a predefined set of basic operations in response to receiving a corresponding basic instruction selected from a predefined native instruction set of codes;
memory, in communication with the processor;
a loading module comprising a set of machine codes selected from the native instruction set for creating data structures for terrains, 3D objects and plane trajectory, wherein terrains are any one or more of: satellite imagery, ground level buildings, trees, terrain, elevation, and other topographic detail, wherein 3D objects are any one or more of: plane of exit, freefalling body of a skydiver, skydiver under open parachute;
a multiplayer module comprising of a set of machine codes selected from the native instruction set for executing a multiplayer thread;
an aeromechanics module comprising of a set of machine codes selected from the native instruction set for executing an aeromechanics thread;
a conversion module comprising of a set of machine codes selected from the native instruction set for converting controller inputs into percent left toggle down and percent right toggle down;
a first querying module comprising of a set of machine codes selected from the native instruction set for querying the aeromechanics thread for position (x, y, z) and attitude (yaw, pitch, roll);
a second querying module comprising of a set of machine codes selected from the native instruction set for querying the multiplayer thread for at least one skydiver position (x, y, z) and attitude (yaw, pitch, roll);
at least one display, for display of a rendered view or image; and
a head mounted display, in communication with the main server.

12. The system of claim 11, wherein execution of the multiplayer thread comprises execution of at least one set of machine codes selected from the native instruction set, wherein each of the at least one set of machine codes is separately configured for:
determining connection of the multiplayer module with the multiplayer game server;
sending at least one skydiver's position (x, y, z) and attitude (yaw, pitch, roll) to the multiplayer game server; and
receiving at least one skydiver's position (x, y, z) and attitude (yaw, pitch, roll) from the multiplayer game server.

13. The system of claim 11, further comprising a head mounted display query module execution of which comprises execution of at least one set of machine codes selected from the native instruction set, wherein each of the at least one set of machine codes is separately configured for querying a head mounted display for yaw, pitch and roll data.

14. The system of claim 11, wherein execution of the aeromechanics thread comprises execution of at least one set of machine codes selected from the native instruction set, wherein each of the at least one set of machine codes is separately configured for:
initializing initial inputs, data points;
populating data structures with aeromechanical coefficients and air density;
execution of an exit phase module comprising of a set of machine codes selected from the native instruction set for determining whether a valid exit condition for an exit phase has been attained, wherein execution of the transition phase module comprises of execution of a skydive phase module;
execution of a freefall phase module comprising of a set of machine codes selected from the native instruction set for determining whether a valid exit condition for a freefall phase has been attained, wherein execution of the transition phase module comprises of execution of a skydive phase module;
execution of a transition phase module comprising of a set of machine codes selected from the native instruction set for determining whether a valid exit condition for an exit phase has been attained, wherein execution of the transition phase module comprises of execution of a skydive phase module; and
execution of a paraglide phase module comprising of a set of machine codes selected from the native instruction set for determining whether a valid exit condition for a paraglide phase has been attained, wherein execution of the transition phase module comprises of execution of a skydive phase module.

15. The system of claim 14, wherein execution of the skydive phase module comprises execution of at least one set of machine codes selected from the native instruction set, wherein each of the at least one set of machine codes is separately configured for:
execution of a space integration subsystem module;
execution of a wind module;
execution of a first aeromechanics subsystem module;
execution of a second aeromechanics subsystem module;
execution of any one or more of: x-subsystem module, y-subsystem module, z-subsystem module; and
execution of a space integration module.
